(19) United States
(12) Patent Application Publication
(10) Pub. No.: US 2026/0096571 A1
(43) Pub. Date: Apr. 9, 2026

(54) DEHYDRATED CREAM AND METHODS OF MAKING AND RECONSTITUTING SAME

(71) Applicant: Cornell University, Ithaca, NY (US)

(72) Inventors: Joseph DUMPLER, Ithaca, NY (US); Carmen I. MORARU, Ithaca, NY (US)

(21) Appl. No.: 19/111,759

(22) PCT Filed: Sep. 13, 2023
(86) PCT No.: PCT/US2023/074120

§ 371 Date: Mar. 13, 2025

Related U.S. Application Data
(60) Provisional application No. 63/375,534, filed on Sep. 13, 2022.

(51) Int. Cl. A23C 13/12

(52) U.S. Cl. CPC A23C 13/125; A23C 2210/00

(57) ABSTRACT

Provided is a process for producing shelf stable dehydrated heavy cream with a shelf-life exceeding 6 months when stored in lightproof packaging at room temperature using gentle homogenization followed by microwave vacuum drying. Also provided is a dehydrated cream made from this method. The dehydrated cream product that can be easily reconstituted with water, either in a blender (household setting) or a rotor-stator homogenizer (industrial scale). The reconstituted dehydrated cream product maintains all the functional properties of the unprocessed heavy cream and allows for either direct utilization or consumption as heavy cream, or the production of whipped cream, ice cream, and butter.

### CROSS REFERENCE TO RELATED APPLICATION

This application claims the benefit of U.S. Provisional Patent Application No. 63/375,534, filed on Sep. 13, 2022, the disclosure of which is incorporated herein by reference.

### BACKGROUND OF THE DISCLOSURE

Milk production will reach new heights, both globally and in the U.S. and so does the amount of milk fat. Most non-fat solids in milk are converted to skim milk powder or non-fat dry milk (NFDM) to achieve a shelf life of up to two years. Not all cream produced in the dairy industry in this process is utilized immediately after it is obtained, and significant amounts need to be preserved and stored to account for seasonal variations in supply and demand. Since the production of NFDM is projected to increase significantly in the upcoming years, there will be an increasing gap between the amount of cream available on the market and its consumption.

Excess cream can be frozen, converted into UHT heavy whipping cream, butter, AMF or spray dried cream powder for long-term storage. None of these products allows for the simple reconstitution to achieve the same level of functionality the original cream had.

Cream is obtained by centrifugal separation of whole raw milk into heavy cream (˜40% fat) and skim milk. Cream is typically used for the manufacture of whipping cream, sour cream, ice cream, butter, or is added to increase the fat content of cheese milk as well as in other food applications (baking, prepared foods, etc.). Not all cream produced in the dairy industry is utilized immediately after it is obtained, and significant amounts need to be preserved and stored to compensate seasonal variations in supply and demand.

Short term refrigerated storage. The refrigerated shelf life of pasteurized heavy cream is about 3 weeks, and of ultra-pasteurized heavy cream is about 6 weeks.

Long term storage options for heavy cream include the following practices: UHT heavy cream, a product less common in the US, is shelf stable at room temperature, but only for a few months. Freezing is the most common way to store cream long term. However, this process destabilizes the structure of the fat globules which limits its utilization post-thawing. Additionally, this requires a cold chain. Shelf stable anhydrous milk fat (AMF) is obtained by an energy intensive centrifugation process (clarifixation/centrifixation) or by churning the cream into butter and removing the water thermally, which allows for a shelf life of several months. AFM cannot be converted back into heavy cream by simple reconstitution. The shelf stable commercially available alternatives represented by ‘cream powders’, which are in fact whole milk powders with elevated fat content, are obtained by intense homogenization, followed by spray drying. Due to the harsh processing conditions, whipping or churning after reconstitution with water of these powders is not possible, and thus they cannot be used to obtain whipped cream, ice cream, and butter, respectively. Some or all technological functionality of the original cream is lost.

Specifically, the homogenization conditions required prior to spray drying of cream into powders generate fat globules that are too small, too stable, and covered by too much milk protein to functionally be whipped into whipped cream, ice cream, or churned into butter after reconstitution with water.

### SUMMARY OF THE DISCLOSURE

The present disclosure provides a process for producing shelf stable dehydrated heavy cream a with a shelf-life exceeding 6 months when stored in lightproof packaging at room temperature using gentle homogenization followed by microwave vacuum drying, and creating a dehydrated cream product that can be easily reconstituted with water, either in a blender (household setting) or a rotor-stator homogenizer (industrial scale). The reconstituted dehydrated cream product maintains all the functional properties of the unprocessed heavy cream and allows for either direct utilization or consumption as heavy cream, or the production of whipped cream, ice cream, and butter.

The present disclosure provides a shelf-stable cream product that can be reconstituted in a household setting and on an industrial scale with minimum shear. The cream can then be whipped to form whipped cream or churned to produce butter.

### BRIEF DESCRIPTION OF THE FIGURES

For a fuller understanding of the nature and objects of the disclosure, reference should be made to the following detailed description taken in conjunction with the accompanying figures.

FIG. 1. Flow chart showing an embodiment of the method for producing a dehydrated cream product.

FIG. 2. Flow chart showing an embodiment of the method for reconstituting the dehydrated cream product.

FIG. 3. A photographic depiction of two embodiments of the dehydrated cream product of the present disclosure.

FIG. 4. A side-by-side photographic comparison of heavy whipping cream and an embodiment of the reconstituted cream product of the present disclosure.

FIG. 5. Flow chart showing an embodiment of the method for producing a dehydrated cream product.

FIG. 6. Flow chart showing multiple alternate embodiments of the method for reconstituting the dehydrated cream product.

FIG. 7. Top—microscopy images of non-homogenized and homogenized cream. Bottom—Apparent viscosity of evaporated cream (43% total solids) homogenized at different homogenization pressures as a function of temperature (left). Viscosity of homogenized evaporated cream as a function of total solids (right).

FIG. 8. The EnWave nutraREV™ commercial scale batch and continuous microwave vacuum drying systems, both as (a) 3D CAD model and (b) real-world installation

FIG. 9. Molds for holding cream.

FIG. 10. Top—visualization of cream after drying for periods of time. Bottom—PLC recording of a microwave vacuum drying run of cream in the EnWave nutraReV™ microwave vacuum drier. Colors of the axis labels correspond to the plots (left) and desorption isotherm for cream (right).

FIG. 11. Three types of dried product: unhomogenized cream on the left, single stage homogenized in the center and two stage homogenized to the right.

FIG. 12. Differences between samples homogenized one-pass or two pass or microwave vacuum dried at different layer thickness as determined by colorimetry were small despite the differences in appearance of the material. L* a* b* color parameters of dehydrated cream produced from cream homogenized at 7 MPa or 7/3.5 MPa and dried with an initial product layer thickness of 2 or 3 mm. Pictures of the corresponding dehydrated cream are shown below for visual comparison. Different lower case letters indicate significant differences (n=4).

FIG. 13. SEM images of the microwave vacuum dried cream showed that homogenization before drying affected not only the macroscopic appearance of the dry material but also its microstructure with 7 MPa (left) and 7/3.5 MPa (right).

FIG. 14. Results of a common test for milk fat containing spray dried powder is the analysis of the amount of free fat, i.e., the amount of fat that can be extracted when the powder is dispersed in a non-polar solvent.

FIG. 15. High-shear mixing devices for reconstitution of microwave vacuum dried cream that we employed are shown in these pictures above. We used a Waring blender, a Thermomix®, which is a temperature-controlled blender, and an UltraTurrax T25 rotor-stator homogenizer. The microscopic images below show—from left to right—the fat globules present in unhomogenized heavy cream and single stage homogenized heavy cream for comparison. On the right, reconstituted microwave vacuum dried cream using the UltraTurrax T25 and the Waring blender is shown.

FIG. 16. Colorimetry data of cream homogenized at different pressures (left) and reconstituted MVD cream produced from cream homogenized at different pressures, L* a* b* color parameters of pasteurized and reconstituted dehydrated cream produced from cream homogenized at 7 MPa or 7/3.5 MPa and dried with an initial product layer thickness of 2 or 3 mm. Different lower-case letters indicate significant differences (n=4) (right).

FIG. 17. Particle size of fat globules in homogenized cream vs. pasteurized cream (left) and reconstituted MVD cream in comparison to pasteurized cream and two-step homogenized cream (right). The right further shows particle size distribution of pasteurized cream (short dash dotted line), cream homogenized at 7 MPa (solid line) and 7/3.5 MPa (broken line), and reconstituted dehydrated cream produced from cream homogenized at 7 MPa (solid lines) or 7/3.5 MPa (dashed lines) and dried with an initial product layer thickness of 2 or 3 mm.

FIG. 18. Visual appearance of pasteurized cream and reconstituted cream (left) and 3D confocal laser scanning microscopy images z-scans (CLSM z-scans) of fat globules in pasteurized cream (a), cream homogenized at 3.5 MPa (b), 7 MPa (c), and 7/3.5 MPa (d), dehydrated cream reconstituted at 18,000 rpm/4 min using the UltraTurrax produced from cream homogenized at 7 MPa (e) or 7/3.5 MPa (f). Milk fat was stained with Nile red (red) and protein was stained with Fast Green FCF (green).

FIG. 19. Side-by-side comparison of whipped cream obtained from regular pasteurized cream (on the left) and whipped cream reconstituted under different conditions using the UltraTurrax high shear rotor-stator homogenizer under different conditions (the 3 samples to the right). Texture analysis of the whipped cream, using a Texture Analyzer fitted with a cream testing probe (graph and image on top).

FIG. 20. Comparison of whipped cream firmness of pasteurized cream homogenized at different homogenization pressures (left) and whipped cream firmness over whipping time for pasteurized cream, and reconstituted MVD cream.

FIG. 21. Butter (left), soft whipped cream, and stiff whipped cream (right) produced from reconstituted MVD cream.

FIG. 22. Desorption isotherm of dehydrated cream depicting the correlation of moisture content of cream and water activity.

FIG. 23. CLSM images (2D) of fat globules in pasteurized cream (a), cream homogenized at 3.5 MPa (b) and 7 MPa (c), and 7/3.5 MPa (d), dehydrated cream reconstituted at 18,000 rpm/4 min using the UltraTurrax produced from cream homogenized at 7 MPa (e) or 7/3.5 MPa (f). Phospholipids were stained with the fluorescent phospholipid analog Rd-DOPE (purple).

FIG. 24. Pasteurized cream and reconstituted dehydrated cream side-by-side in beakers (a), TA-XT plus texture analyzer and cream probe in the top left corner (b), whipped cream from pasteurized cream (c), and whipped cream from reconstituted dehydrated cream (d).

FIG. 25. Whipped cream firmness from 30.5% fat cream depending on homogenization conditions of cream. The Texture Analyzer graph with anchors at 4 and 6 s as well as the average firmness is also shown (left). Whipped cream firmness of pasteurized cream (38% fat) and reconstituted dehydrated cream produced from cream homogenized at 7 MPa or 7/3.5 MPa as a function of whipping time (right).

FIG. 26. Water activity of MVD cream powder packaged in airtight metalized barrier pouches flushed with N₂, during room temperature (25° C.) and accelerated storage conditions (40° C.)

FIG. 27. L-a-b color parameters for MVD cream powder packaged in airtight metalized barrier pouches flushed with N₂, during room temperature (25° C.) and accelerated storage conditions (40° C.).

FIG. 28. L-a-b color parameters for reconstituted cream obtained from MVD powder packaged in airtight metalized barrier pouches flushed with N₂, during room temperature (25° C.) and accelerated storage conditions (40° C.).

FIG. 29. Firmness of reconstituted cream obtained from MVD powder packaged in airtight metalized barrier pouches flushed with N₂, during room temperature (25° C.) and accelerated storage conditions (40° C.).

FIG. 30. Particle size for reconstituted cream obtained from MVD powder packaged in airtight metalized barrier pouches flushed with N₂, during room temperature (25° C.) and accelerated storage conditions (40° C.).

FIG. 31. Volatiles (1-octen-3-ol and 2-heptanone) from MVD cream powder packaged in airtight metalized barrier pouches flushed with N₂, during room temperature (23° C.) and accelerated storage conditions (40° C.).

FIG. 32. Volatiles (Heptanal, Octanal, Nonanal,) from MVD cream powder packaged in airtight metalized barrier pouches flushed with N₂, during room temperature (23° C.) and accelerated storage conditions (40° C.).

FIG. 33. Volatiles (Hexanal) from MVD cream powder packaged in airtight metalized barrier pouches flushed with N₂, during room temperature (23° C.) and accelerated storage conditions (40° C.).

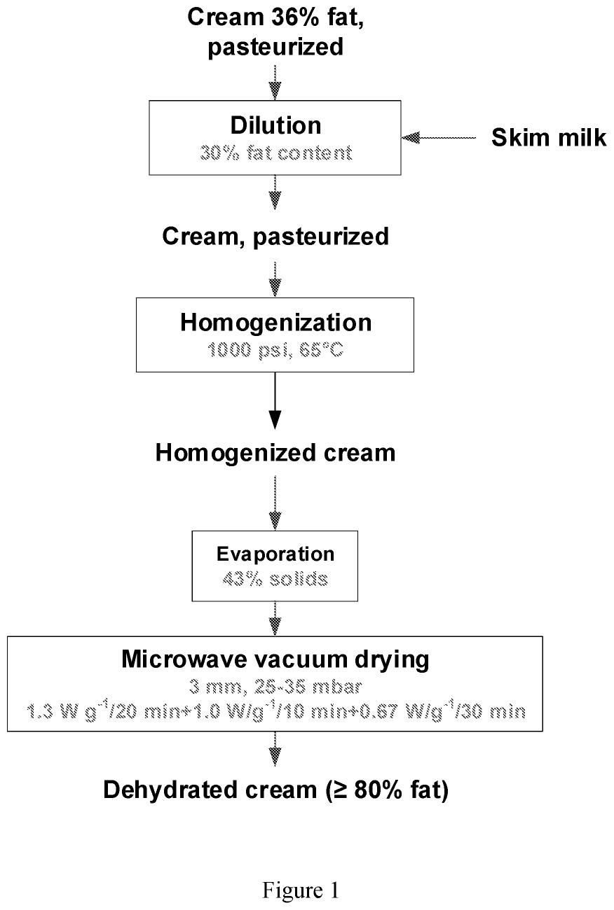

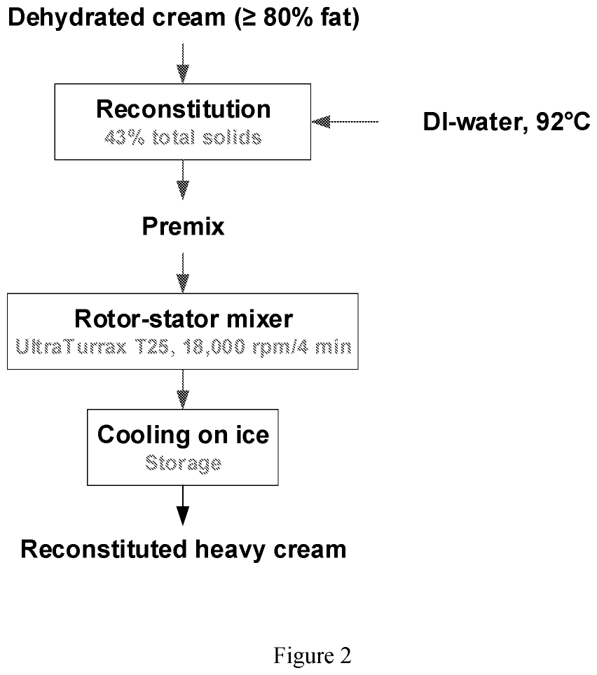

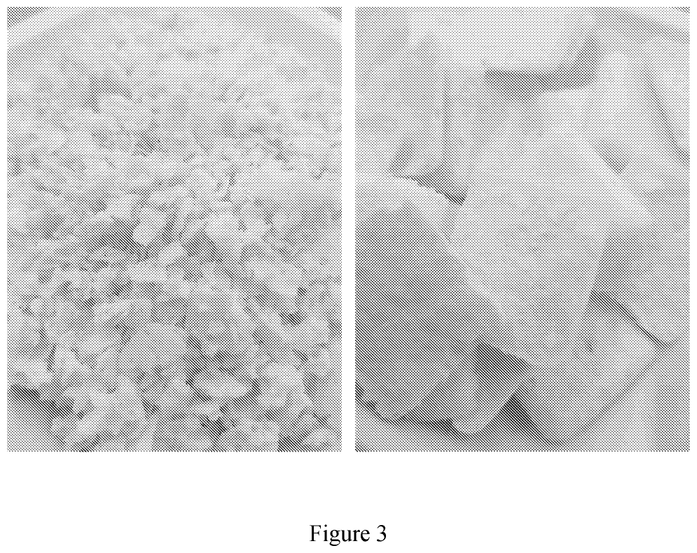

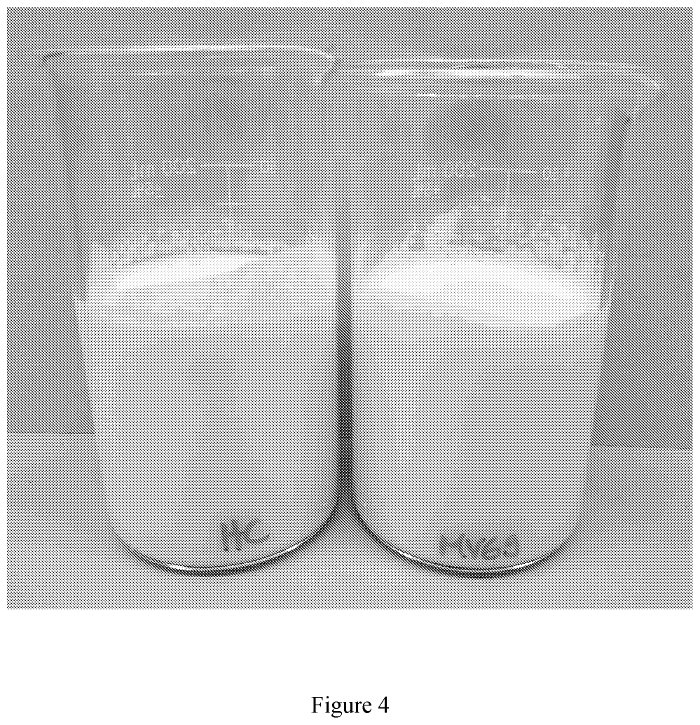

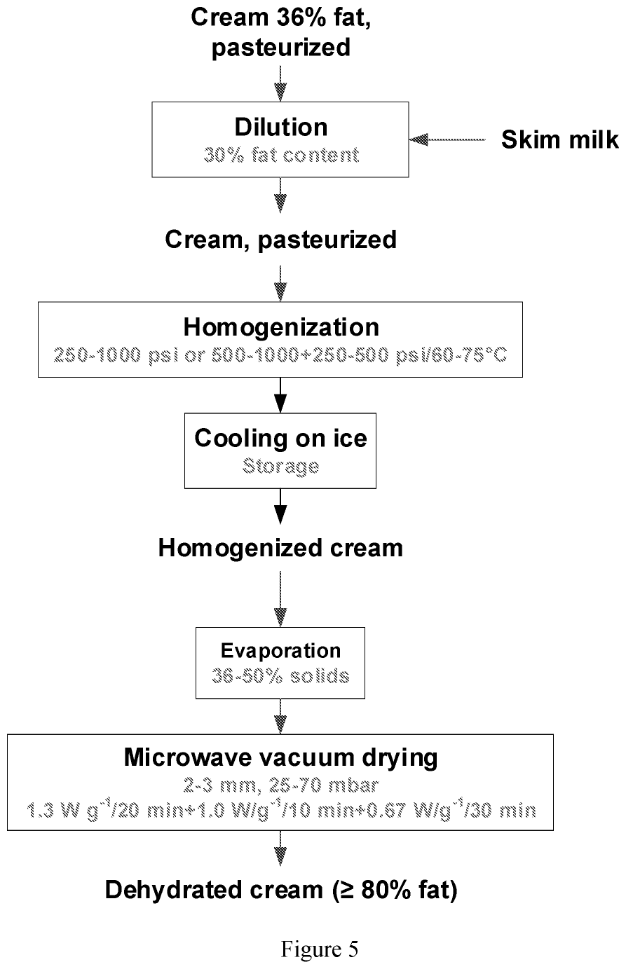

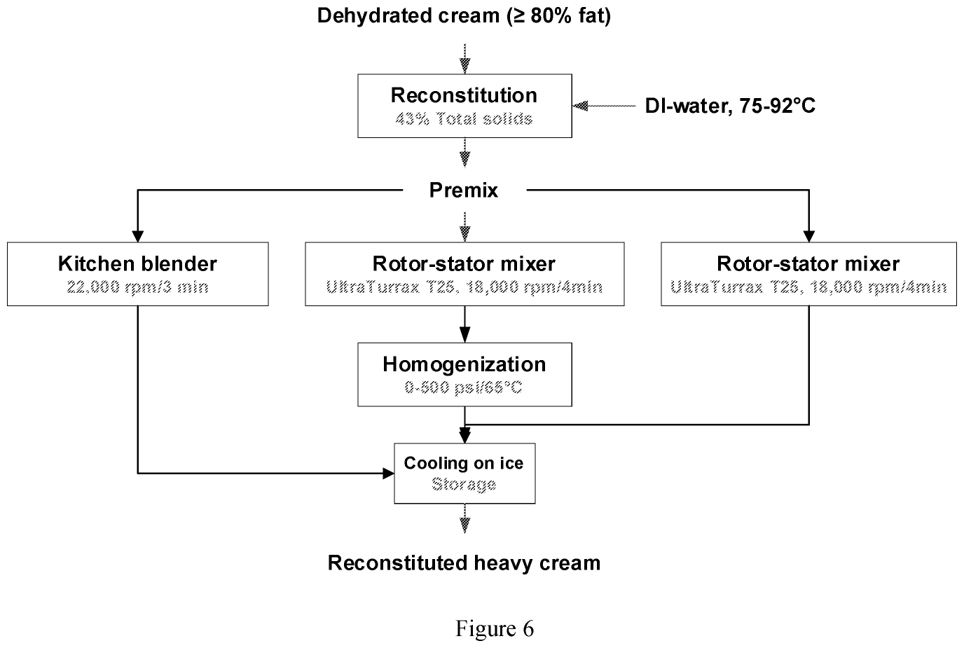

### DETAILED DESCRIPTION OF THE DISCLOSURE

Although claimed subject matter will be described in terms of certain examples and embodiments, other examples and embodiments, including examples that do not provide all of the benefits and features set forth herein, are also within the scope of this disclosure. Various structural, logical, and process step changes may be made without departing from the scope of the disclosure.

As used herein, unless otherwise indicated, “about”, “substantially”, or “the like”, when used in connection with a measurable variable (such as, for example, a parameter, an amount, a temporal duration, or the like) or a list of alternatives, is meant to encompass variations of and from the specified value including, but not limited to, those within experimental error (which can be determined by, e.g., a given data set, an art accepted standard, etc. and/or with, e.g., a given confidence interval (e.g. 90%, 95%, or more confidence interval from the mean), such as, for example, variations of +/−10% or less, +/−5% or less, +/−1% or less, and +/−0.1% or less of and from the specified value), insofar such variations in a variable and/or variations in the alternatives are appropriate to perform in the instant disclosure. As used herein, the term “about” may mean that the amount or value in question is the exact value or a value that provides equivalent results or effects as recited in the claims or taught herein. That is, it is understood that amounts, sizes, compositions, parameters, and other quantities and characteristics are not and need not be exact, but may be approximate and/or larger or smaller, as desired, reflecting tolerances, conversion factors, rounding off, measurement error, or the like, or other factors known to those of skill in the art such that equivalent results or effects are obtained. In general, an amount, size, composition, parameter, or other quantity or characteristic, or alternative is “about” or “the like,” whether or not expressly stated to be such. It is understood that where “about,” is used before a quantitative value, the parameter also includes the specific quantitative value itself, unless specifically stated otherwise.

Ranges of values are disclosed herein. The ranges set out a lower limit value and an upper limit value. Unless otherwise stated, the ranges include the lower limit value, the upper limit value, and all values between the lower limit value and the upper limit value, including, but not limited to, all values to the magnitude of the smallest value (either the lower limit value or the upper limit value) of a range. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “0.1% to 5%” should be interpreted to include not only the explicitly recited values of 0.1% to 5%, but also, unless otherwise stated, include individual values (e.g., 1%, 2%, 3%, and 4%) and the sub-ranges (e.g., 0.5% to 1.1%; 0.5% to 2.4%; 0.5% to 3.2%, and 0.5% to 4.4%, and other possible sub-ranges) within the indicated range. It is also understood (as presented above) that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about, it will be understood that the particular value forms a further disclosure. For example, if the value “about 10” is disclosed, then “10” is also disclosed.

The present disclosure provides a process for the manufacture of dehydrated cream by microwave vacuum drying to obtain a shelf stable dry product with superior functional properties. Also provided is a dehydrated cream product. This dehydrated cream product can be reconstituted by high shear mixing to achieve similar functional properties as compared to the unprocessed cream. The dry product can be whipped or churned to obtain whipped cream, ice cream, and butter, respectively. Such a product does not exist on the market, as cream powder products currently sold are obtained by spray drying of concentrated milk with a high fat content, after intense homogenization, and do not retain unprocessed cream's functional properties upon reconstitution with water.

The present disclosure provides a method manufacture dehydrated, shelf stable cream that can be reconstituted into cream with similar functionality as fresh, pasteurized cream. Such functionality is not possible using conventional processes using spray drying. The scientific findings presented herein can provide a unique and innovative solution for milk fat long term storage, transportation, and utilization.

In an aspect, the present disclosure provides a method for producing a dehydrated cream product. In various embodiments, the method comprises drying a cream composition to produce a dehydrated cream product.

In embodiments, the method comprises providing a dairy cream composition having a fat content of 8-36% fat by mass; homogenizing the cream composition such that in the homogenized cream composition, at least 80% of the fat globules or clusters of fat globules have a diameter of 1-10 μm; and subjecting the homogenized cream composition to vacuum drying to result in a dehydrated cream product having a fat content of 45-86% by mass and a moisture content of less than or equal to 1.5% by mass.

In embodiments, the method further comprises diluting a high milk-fat cream (e.g., diluting with dairy milk, skim milk, water, or other composition) to obtain the cream composition.

In an embodiment, the method may comprise homogenization of a cream composition as a pre-drying processing step. The homogenization of the cream composition is optimized with respect to the protein-to-fat ratio in the cream composition, the homogenization pressure and temperature, and cream viscosity. The optimal protein-to-fat ratio is 1:11-1:21 by weight. The optimal homogenization conditions for cream prior to drying are 3.5-7 MPa, and 45-85° C., performed as single- or two-stage homogenization or one or multiple passes. The optimal cream viscosity is 30-200 mPas at 20° C. The optimized parameters may be generated to result in desirable processing and whipping properties after reconstitution. In embodiments, the parameters that are optimized for desirable properties are, for example, the percent content by weight of fat in the cream composition, or the homogenization pressures.

In an embodiment, the method may include subjecting a cream composition to microwave vacuum drying (MVD). The microwave vacuum drying of a cream composition (e.g., homogenized heavy cream or diluted heavy cream (e.g., heavy cream diluted with skim milk or water) and homogenized) in thin layers allows for fast and even drying, low product temperatures during the drying process, and limited oxidation of fat during the drying process.

In embodiments, the reconstitution conditions of the dehydrated cream product (e.g., microwave vacuum dried heavy cream) may use high shear mixing. For example, the high shear mixing may be performed using a blender, single-stage rotor-stator homogenizer, multi-stage rotor-stator homogenizer, in-line colloid mill, batch colloid mill, or similar device.

In one embodiment, the dehydrated cream product does not require aseptic filling or refrigerated storage. In other words, the dehydrated cream product may be shelf stable at room temperature. In embodiments, the dehydrated cream product can remain stable at room temperature for 6-12 months. In various embodiments, the dehydrated cream product is stable at room temperature for at least 6 months.

In an embodiment, the reconstituted heavy cream may have full or near full retention of key functional characteristics of unprocessed cream. In the context of the present application, “unprocessed cream” is understood to refer to a liquid dairy cream which has not been subjected to the method or any step of the method of the present disclosure (e.g., commercially available heavy whipping cream or heavy cream). “Unprocessed cream” may or may not be subjected to common industry preparations for commercial sale such as, for example, pasteurization or other heat treatment, homogenization, dilution, evaporation, and/or the like. For example, in some embodiments the reconstituted heavy cream can be whipped to obtain whipped cream, ice cream, or churned to obtain butter. This whipped cream or butter can be used in the same way as products obtained from unprocessed cream. The reconstituted cream and the butter and whipped cream obtained from the reconstituted cream can be used in a consumer household setting or in industry (e.g., using the reconstituted cream as a replacement for unprocessed heavy cream, as ice cream ingredient, as coffee creamer, for cooking, baking, or any other food application).

In an aspect, the disclosure provides a dehydrated cream product. The dehydrated cream product may comprise 45-86% fat by mass (e.g., 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86%) and less than or equal to 1.5% water by mass. In embodiments, the dehydrated cream composition may comprise about 78% fat by mass (e.g., 78% fat by mass).

In embodiments, the dehydrated cream product comprises a residual moisture content corresponding to a water activity of 0.35 or less.

In an embodiment, at least some of the fat of the dehydrated cream product is fat globules, and when the dehydrated cream product is reconstituted, at least 80% of the fat globules have a largest linear dimension (e.g., diameter) of 1 to 20 μm (e.g., 1, 2, 3, 4, 5, 6, 7, 8, 9, 10, 11, 12, 13, 14, 15, 16, 17, 18, 19, 20 μm).

In some embodiments, the dehydrated cream product does not comprise vegetable fats. In some embodiments, the fat of the dehydrated cream product is milk fat. In embodiments, the cream composition is a milk cream comprising milk cream from a mammal (e.g., from a cow, a goat, an ewe, a camel, or a buffalo). In some embodiments, the dehydrated cream product comprises vegetable fats, where the vegetable fats comprise less than 50% of the total fat by mass. In various embodiments, the dehydrated cream product does not contain any vegetable fat.

In embodiments, the cream composition may be heat treated (e.g., pasteurized), high heat treated, ultra-pasteurized, ultra-high temperature heat treated, or sterilized. The cream composition can also be subjected to any other heat treatment or non-thermal pasteurization process.

In various embodiments, the cream composition comprises a protein-to-fat ratio greater than or equal to 1:21. In embodiments, the ratio 1:21 corresponds to 36% fat by mass and 41.5% total solids whereby the non-fat solids contain 1.7% protein by mass. In various embodiments, the cream composition may have 36% fat by mass and 5.5% non-fat solids by mass (e.g., 41.5% total solids by mass). In embodiments, the cream composition may have 30% fat by mass and 5.5% non-fat solids by mass (e.g., 35.5% total solids by mass).

Without intending to be bound by any particular theory, it is considered that modifying the protein-to-fat ratio can affect homogenization. A smaller ratio may be beneficial for homogenization; however, a larger ratio may be used to improve the ability to form a whipped cream from the reconstituted cream of the present disclosure.

In various examples, the method of the present disclosure comprises providing a dairy cream composition having a fat content of 8-36% fat by mass (e.g., 26-30% fat). The method may further comprise homogenizing the cream composition such that about 80% of the fat globules of the homogenized cream composition have a diameter of 0.25-5 μm. The apparent size distribution of fat globules may have 80% of the globules having a diameter of 1.2-8 μm with about 60% of the fat globules present as clusters.

In embodiments, the cream composition may have a protein-to-fat ratio of greater than or equal to 1:21. In embodiments, the cream composition may comprise 20-35% fat. In other embodiments, the cream composition may comprise a protein-to-fat ratio of from 1:10 to 1:21 (e.g., 1:11 to 1:21).

The protein-to-fat ratio, in combination with the other aspects of the present disclosure, can impact the size and stability of the fat globules in the unprocessed cream composition, the homogenized cream composition, the dehydrated cream product, and the reconstituted cream composition of the present disclosure. Without intending to be bound to any specific theory, it is considered that the interactions between protein and milk phospholipids at the surface of the fat globules is related to the functional properties of unprocessed cream (e.g., the ability to whip cream into whipped cream, ice cream, or to churn cream into butter). Generally unaltered or pasteurized dairy cream is an emulsion comprising an aqueous continuous phase and a milk fat disperse phase. Because the milk fat and the aqueous phase are immiscible, the fat forms spherical or spheroid globules, each having a nonpolar core and a milk fat membrane enclosing the core. The native milk fat globule membrane comprises mostly proteins and phospholipids, which comprise a hydrophobic tail and a hydrophilic head that allows the phospholipid to orient itself between the polar aqueous phase and the nonpolar fat core of the globule. The aqueous phase also comprises non-fat milk solids, including milk proteins. After homogenization, the native milk fat globule membrane is partially lost, and milk proteins adsorb to the surface of the homogenized fat globules, which increases their stability. The stability of the fat globule and the new secondary milk fat globule membrane formed after homogenization is strengthened by increased protein coverage.

Homogenization of cream decreases the size of the fat globules and increases the number of discrete globules present in the emulsion increases. Homogenization also increases the total collective surface area of the fat globules. Manipulating the homogenization conditions of a cream composition will directly impact at least the following: the size of the fat globules, the number of fat globules, the collective surface area of fat globules, the protein coverage of the fat globules, and the stability of the globules.

Without intending to be bound by any particular theory, it is considered that the stability and size of the fat globules in the cream composition affect the whipping and churning functional properties of the cream composition. Whipping and churning generally comprise agitating the cream emulsion composition, causing the fat globules to cluster on contact and adsorb at the surface of air bubbles, thereby building a stable foam structure. Continued agitation (e.g., churning) of the emulsion will enable separation of the nonpolar fat phase from the polar aqueous phase as the fat globules further combine and cluster to form a solid or semisolid mass. The solid mass of milk fat is butter.

If a cream composition is homogenized such that, for example, 90% of the fat globules are smaller than or equal to 2 μm, the fat globules will be stabilized by protein such that whipping and churning will not be possible. The small, protein-covered fat globules will not cluster and combine in part due to the layer of protein, a so-called secondary fat globule membrane, covering and protecting each milk fat globule, preventing it from merging with other fat globules during whipping.

Without intending to be bound to any particular theory, unaltered or pasteurized unhomogenized cream composition has native fat globules. These native fat globules are covered with a native fat globule membrane, enabling them to remain globules, and allowing whipping or churning functional properties. Methods of drying unaltered or pasteurized cream without homogenizing it can rupture fat globules and result in a separation of the fat phase during drying. Therefore, some amount of homogenization can stabilize the globules enough to avoid rupturing and separation during a drying process, but not stabilize the globules to a level that would impede whipping or churning capability after reconstitution.

Without intending to be bound to any particular theory, the dehydrated cream product may comprise ruptured globules, or pockets of fat within the dried composition which are not completely encased in a milk fat globule membrane. However, it is thought that the dried product contains fat, milk phospholipids, and proteins in a sufficient spatial relationship to one another (e.g., the components are dispersed in the composition in a sufficient arrangement of volume and proximity) to enable the reformation of globules when rehydrated (e.g., reconstituted). The conditions of the cream composition before drying, during drying, and during reconstitution, as disclosed herein, can produce a product that will form globules upon reconstitution. These globules are of the appropriate size and have the appropriate coverage of protein at their surface to enable whipping and churning capability after reconstitution.

The method may further comprise subjecting the homogenized cream composition to vacuum drying to result in a dehydrated cream product having a fat content of 45-86% by mass, and a moisture content of less than or equal to 1.5% by mass.

In an embodiment, the homogenizing step may comprise subjecting the cream composition to high-pressure homogenization between 250-1000 psi. In embodiments the homogenization step may comprise subjecting the cream composition to high-pressure homogenization between 250-500 psi. The homogenization step may comprise first subjecting the cream composition to high-pressure homogenization between 250-1000 psi, and subsequently subjecting the cream composition to high-pressure homogenization between 250-500 psi.

In embodiments, the homogenizing step may be performed at 0-10 MPa. The homogenizing step may comprise a single stage, two-stage, single pass, or multiple passes. The homogenizing step should reduce or significantly reduce the size of individual fat globules in the cream composition. After homogenization, the individual fat globules should at least be partially covered by milk protein, which means serum protein and casein, as can be observed by, for example, confocal laser scanning microscopy. The coverage of the fat globule (e.g., the coverage of the surface of the fat globule) by protein will increase the fat globule stability and prevent coalescence during drying. Cluster formation may increase the observed particle size (i.e., laser light scattering may read the size of a cluster of globules as a single particle), especially in embodiments where single-stage or single pass homogenizing is used. Embodiments comprising two-stage homogenization may reduce the viscosity of the homogenized cream composition as compared to single-stage homogenization.

In embodiments, the homogenizing step may comprise a first stage where the cream composition is homogenized at a pressure of 7 MPa. The homogenizing step may further comprise a second stage, after the first stage, where the cream composition is homogenized at a pressure of 3.5 MPa.

In embodiments of the method of the present disclosure, the temperature of the cream composition is equal to or lower than 85° C. In embodiments, the temperature of the cream composition does not exceed 85° C. during the homogenizing step or the vacuum drying step. The temperature of the cream composition may be, for example, 45-85° C. during the various stages of the method (e.g., homogenizing step, heat treatment, evaporating step, and drying step). In embodiments, the temperature of the cream composition is 45-85° C. in the homogenizing step, and the temperature of the cream composition is equal to or lower than 65° C. during the drying step.

In embodiments, the method comprises cooling the cream composition for storage before evaporation and/or before drying. In embodiments, the cream composition may be cooled to a temperature of 4 to 10° C.

The pre-drying processing parameters of the disclosed method or a temperature-controlled drying process or a continuous microwave vacuum drying process can keep the cream composition temperature at or below 65° C. to prevent excessive separation of fat and non-fat solids during drying.

In various embodiments, the vacuum drying can be microwave vacuum drying, freeze drying, or vacuum drum drying. In various embodiments, the vacuum drying can comprise conductive heat transfer, convection, or radiative heat transfer such as infrared radiation, radio frequency or microwaves. In some embodiments, other drying methods that may or may not include vacuum are used instead of vacuum drying (e.g., spray drying, freeze drying, drum drying, conductive heat transfer, convection, or radiative heat transfer such as infrared radiation, radio frequency or microwaves). Additionally, any combinations of multiple drying techniques are also contemplated (e.g., microwave vacuum drying combined with conductive heat transfer).

In embodiments, the vacuum drying does not comprise conductive heat transfer, convection, radiative heat transfer such as infrared radiation (e.g., glowing wire), radio frequency, or microwaves.

In embodiments, the vacuum drying step further comprises a first step of subjecting the cream composition to microwave radiation of 0.2-3 W (e.g., 1.3 W) per g of cream composition for about 20 minutes. The method may further comprise a second step, after the first step, of subjecting the cream composition to microwave radiation of 0.2-3 W (e.g., 1.0 W) per g of cream composition for about 10 minutes. The method may further comprise a third step, after the second step, of subjecting the cream composition to microwave radiation of 0.2-3 W (e.g., 0.67 W) per g of cream composition for about 30 minutes.

In embodiments, the vacuum drying may have a vacuum pressure of 1-10 kPa. In embodiments the vacuum drying may have a vacuum pressure of 2.5-3.5 kPa.

In embodiments, prior to drying, the cream composition may be present as a liquid in a layer with a thickness of 1-4 mm. In embodiments, the cream composition layer thickness will decrease over the duration of the drying step.

In embodiments, prior to the drying step, the method may further comprise evaporating the cream composition. In embodiments, the evaporating step may result in a cream composition with 30 to 50% solids by mass (e.g., 36-50% solids by mass). In embodiments, the evaporating step may result in a cream composition with 43% solids by mass. The evaporating step may result in a cream composition with 30-45% fat by mass. In embodiments, the evaporating step may result in a cream composition with equal to or less than 40% fat by mass.

In embodiments, the evaporating step comprises concentrating the cream composition to 36-50% solids by mass at 45-85° C. The evaporating step may be performed in a single or multi effect evaporator.

In embodiments, the method further comprises adding an additive (e.g., a colorant, sweetener, salt, flavoring, fruits, vegetables, spices, preservatives, hydrocolloids, stabilizers, emulsifiers or other food preparations) to the cream composition or the dehydrated cream product.

In an aspect, the disclosure provides a dehydrated cream product produced by the method disclosed.

In embodiments, the dehydrated cream product does not comprise preservatives, hydrocolloids, stabilizers, or emulsifiers.

In embodiments, the dehydrated cream product may comprise preservatives, hydrocolloids, stabilizers, or emulsifiers.

In embodiments the dehydrated cream product is shelf-stable at room temperature for at least 6 months.

In embodiments the dehydrated cream product, when rehydrated to produce reconstituted heavy cream, can be whipped to obtain whipped cream, ice cream, or churned to obtain butter.

In another aspect, the disclosure provides a method of making reconstituted cream, butter, ice cream, or whipped cream. In embodiments, the method comprises adding an aqueous media to the dehydrated cream product of the disclosure, mixing the aqueous media and dehydrated cream product to form a reconstituted heavy cream.

In embodiments, the method comprises adding an aqueous media (e.g., water) to the dehydrated cream product in a ratio of aqueous media to dehydrated cream of from 5:3 to 20:17 by mass.

In embodiments, the mixture of dehydrated cream product and aqueous media may be heated to 50-80° C. In embodiments, the aqueous media may be from 70-100° C. (e.g., from 75-92° C.) when mixed with the dehydrated cream product. In embodiments, the dehydrated cream product may be at room temperature when mixed with the aqueous media.

In embodiments, the mixing may be high shear mixing, and may be performed with, for example, a blender, single-stage rotor-stator homogenizer, multi-stage rotor-stator homogenizer, in-line colloid mill, batch colloid mill, or similar device. The mixing may be performed, for example, with an available consumer kitchen blender or smoothie maker for 2-5 minutes. The mixing may be performed, for example, with a rotor-stator mixer at 15,000-24,000 RPM for 2-5 minutes.

In embodiments, the mixing may have local shear rates or gradients of at least 10⁻⁴ s⁻¹. In embodiments, the mixing may have a power density of at least 10⁹ J m⁻³.

In embodiments, the method may further comprise a homogenizing step after the high shear mixing step. This homogenizing of the reconstituted heavy cream can be performed, for example, at 3.5 MPa. This homogenizing may also be performed at 55-75° C.

In various embodiments, the method may also comprise cooling the mixture of the dehydrated cream product and the aqueous media. In embodiments, the cooling step may at least partially crystallize the milk fat in the mixture.

In some embodiments an additive is used. The additive can be introduced to the dehydrated cream product, the aqueous media, or the reconstituted mixture at any point in the disclosed method (e.g., before mixing, during mixing, after mixing, before homogenization, after homogenization, etc.). The additive may be a colorant, sweetener, salt, flavoring, hydrocolloid, emulsifier, fruits, vegetables, spices, or other food preparations. In some embodiments, the additive may already be present in the dehydrated cream product or in the aqueous media.

In an aspect of the present disclosure, a reconstituted heavy cream is provided. In various embodiments, the reconstituted heavy cream is an emulsion comprising particles, such as, for example, fat globules. The reconstituted heavy cream may, upon whipping, form whipped cream, or be used to make ice cream. The reconstituted heavy cream may, upon churning, form butter.

In embodiments, at least 90% of the fat globules in the reconstituted heavy cream are smaller than or equal to 20 μm in diameter. In embodiments, at least 90% of the fat globules are larger than or equal to 1 μm in diameter.

In embodiments, the reconstituted heavy cream has fat globules at least partially coated in protein in a protein-to-fat mass ratio of 1:21 (e.g., 1 part protein by mass to 21 parts milk fat by mass). In embodiments, the protein-to-fat ratio is greater than 1:21 (e.g., 1:20 or 1 part protein by mass to 20 parts milk fat by mass). A greater protein-to-fat ratio should be understood to mean a greater amount of protein relative to the same amount of fat.

In embodiments, the particles (e.g., the globules) of the reconstituted heavy cream have a volume-weighted mean diameter of D_{4,3} of 7-8 μm.

In an aspect, the disclosure provides a food product comprising the reconstituted cream, butter, or whipped cream produced by the method of the present disclosure. In another aspect, a food product comprising the reconstituted heavy cream of the present disclosure is provided. In embodiments, the food product may comprise the whipped cream or butter produced from the reconstituted heavy cream of the present disclosure.

In embodiments, the food product may be, for example, a beverage, yogurt, cheese, cream, sauce, spread, dip, condiment, dressing, dessert, snack, baked good, or bread product.

In another aspect, the disclosure provides a kit for preparing reconstituted cream or butter. In embodiments, the kit comprises a pre-determined amount of dehydrated cream product and an aqueous media. The dehydrated cream composition may have less than or equal to 1.5% water by mass and/or 45-86% fat by mass. In embodiments, at least some of the fat in the dehydrated cream composition is fat globules. In embodiments, the volume of the aqueous media is pre-determined to reconstitute the pre-determined amount of dehydrated cream product.

The steps of the method described in the various embodiments and examples disclosed herein are sufficient to carry out the methods of the present invention. Thus, in an embodiment, the method consists essentially of a combination of the steps of the methods disclosed herein. In another embodiment, the method consists of such steps.

The following Statements provide various embodiments of the present disclosure. They are not intended to be limiting.

Statement 1. A dehydrated cream product, comprising: 45-86% fat by mass; and, less than or equal to 1.5% water by mass, wherein at least some of the fat is fat globules (e.g., at least a portion of the fat is present as fat globules), and when the dehydrated cream product is reconstituted, at least 80% of the fat globules have a longest linear dimension (e.g., diameter) of 1 to 20 μm.

Statement 2. A dehydrated cream product of Statement 1, wherein the dehydrated cream product does not comprise preservatives, hydrocolloids, stabilizers, and/or emulsifiers.

Statement 3. A dehydrated cream product of any one of the previous Statements, wherein the fat comprises milk fat.

Statement 4. A dehydrated cream product of any one of the previous Statements, wherein the fat comprises less than 50% by mass vegetable fats.

Statement 5. A dehydrated cream product of any one of the previous Statements, wherein the protein-to-fat ratio is greater than or equal to 1:10 (e.g., greater than or equal to 1:20 or greater than or equal to 1:21).

Statement 6. A method for producing a dehydrated cream product, comprising: providing a dairy cream composition comprising emulsified solids comprising fat, wherein at least a portion of the fat is present as fat globules (e.g., comprising fat in fat globules), wherein the cream composition has a fat content of 8-36% by mass; homogenizing the cream composition such that in the homogenized cream composition, 80% of the fat globules or clusters of fat globules have a diameter of 0.25-10 μm; and, subjecting the homogenized cream composition to vacuum drying to result in a dehydrated cream product having a fat content of 45-86% by mass, and a moisture content of less than or equal to 1.5% by mass.

Statement 7. A method of Statement 6, wherein the homogenizing step further comprises: subjecting the dairy cream composition to high-pressure homogenization of 0.01 to 7 MPa (e.g., between 0-7 MPa); and subjecting the cream composition to high-pressure homogenization of 0.01 to 3.5 MPa (e.g., between 0-3.5 MPa).

Statement 8. A method of Statements 6 or 7, wherein the vacuum drying is microwave vacuum drying.

Statement 9. A method of any one of Statements 6-8, wherein the dairy cream product is maintained at a temperature lower than or equal to 65° C., and the method further comprises subjecting the cream composition to microwave radiation of 0.01-2.6 W per g of dairy cream composition (e.g., 1.3 W, 1.0 W, 0.67 W per g of dairy cream composition or between 0 and 2.6 W per g of dairy cream composition) for 5-90 minutes (e.g., 5 minutes, 10 minutes, 20 minutes, 30 minutes, 60 minutes, 90 minutes), wherein the dairy cream composition comprises a layer having a thickness of 1-4 mm.

Statement 10. A method of Statement 9, wherein the microwave radiation is lowered at least once (e.g., 1, 2, 3, or 4 times).

Statement 11. A method of Statement 6, further comprising: evaporating the homogenized cream composition prior to vacuum drying resulting in formation of solids at a concentration 30-50% by mass (e.g., 36-50% by mass) (e.g., such that the solids have a concentration of 30-50% by mass or 36-50% by mass).

Statement 12. A dehydrated cream product prepared by the method of any one of Statements 6-11.

Statement 13. A dehydrated cream product of Statement 12, wherein at least some of the fat is fat globules, and when the dehydrated cream product is reconstituted, at least 80% of the fat globules have a longest linear dimension (e.g., diameter) of 1 to 15 μm.

Statement 14. A dehydrated cream product of Statements 12 or 13, wherein upon adding an aqueous media to the dehydrated cream product and subjecting the dehydrated cream product to high shear mixing, a reconstituted heavy cream is produced, wherein the reconstituted heavy cream is capable of being churned into butter.

Statement 15. A method of making reconstituted cream, butter, or whipped cream, comprising: adding an aqueous media to the dehydrated cream product of any one of the preceding Statements; mixing the aqueous media and dehydrated cream product to form a reconstituted heavy cream, wherein the mixing is high shear mixing.

Statement 16. A method of making butter or whipped cream, comprising: adding an aqueous media to the dehydrated cream product of any one of the preceding Statements; mixing the aqueous media and dehydrated cream product to form a reconstituted heavy cream, wherein the mixing is high shear mixing; and whipping the reconstituted heavy cream to result in whipped cream or churning the reconstituted heavy cream to result in butter.

Statement 17. A method of Statement 15 or Statement 16, wherein the high shear mixing has local shear rates of at least 10⁻⁴ s⁻¹ and a power density of at least 10⁹ J m⁻³.

Statement 18. A method of any one of Statements 15-17, wherein the reconstituted heavy cream is an emulsion comprising fat globules, and wherein at least 90% of the fat globules are smaller than or equal to 14 μm in diameter.

Statement 19. A method of Statement 18, wherein the fat globules have a volume-weighted mean diameter of D_{4,3} of 7-8.5 μm.

Statement 20. A food product, comprising the reconstituted cream of Statement 15 (e.g., a reconstituted cream made by a method of Statement 15).

Statement 21. A food product of Statement 20, wherein the food product is a beverage.

Statement 22. A food product of Statement 20, wherein the food product is a beverage, yogurt, cheese, cream, sauce, spread, dip, condiment, or dressing.

Statement 23. A food product of Statement 20, wherein the food product is a dessert, a snack, a baked good, a pastry, or a bread product.

Statement 24. A kit for preparing reconstituted cream or butter, comprising: a pre-determined amount of dehydrated cream product, having less than or equal to 1.5% water by mass and having 45-86% fat by mass; and, an aqueous media, wherein the volume of the aqueous media is pre-determined to reconstitute the pre-determined amount of dehydrated cream product.

Statement 25. A method for preparing a dehydrated milk cream product, the method comprising: obtaining milk cream comprising 26-30% w/w fat content and has a protein-to-fat ratio of 1:10 to 1:21 (e.g., 1:11 to 1:21); homogenizing the milk cream 7 MPa in the first stage and 3.5 MPa in the second stage at 65-70° C. to generate a homogenized milk cream; evaporating the homogenized milk to 43% w/w solids to generate an evaporated milk cream; and, microwave vacuum drying the evaporated milk cream to generate a dehydrated milk cream product with 45-86% w/w fat, preferably 78% w/w fat or greater, and a residual moisture content of 1.5% w/w or less corresponding to a water activity of 0.35 or less. Drying conditions in a batch microwave vacuum dryer comprise a milk cream layer thickness of 3 mm, a drying pressure of 2.5-3.5 kPa, and a three-step drying process at 1.3 W g⁻¹ for 20 minutes, 1.0 W g⁻¹ for 10 minutes, and 0.67 W g⁻¹ for 30 minutes. Processing parameters of the described process or a temperature-controlled drying process or a continuous microwave vacuum drying process are intended to keep the product temperature below 65° C. to prevent excessive separation of fat and non-fat solids during drying.

Statement 26. A method of Statement 25, wherein the milk cream comprises 26-30% fat and has a protein-to fat ratio of 1:10 to 1:20 (e.g., 1:11 to 1:15).

Statement 27. A method of any one of Statements 25 or 26, wherein homogenizing comprises homogenization at 0-10 MPa single stage or two-stage, single pass, or multiple passes at 45-85° C. Sizes of individual fat globule should be significantly reduced. Homogenized fat globules should be covered by milk protein as can be observed by confocal laser scanning microscopy. Coverage of fat globules with milk protein helps increasing fat globule stability and to prevent coalescence during drying. Cluster formation may increase apparent particle size as observed by laser light scattering, especially when single-stage or single pass homogenization is used. Two-stage homogenization of cream is preferred as it reduces the viscosity of homogenized cream as compared to single stage homogenization, improves the structure of dried cream, and improves the functionality of the reconstituted cream.

Statement 28. A method of any one of Statements 25-27, wherein evaporating comprises concentrating cream to 30-50% w/w solids (e.g., 36-50% w/w solids) at 45-85° C. in a single or multi effect evaporator.

Statement 29. A method of any one of Statements 25-28, wherein drying comprises a microwave drying process, batch or continuous, wherein a milk cream layer thickness of 1-4 mm, a drying pressure of 1-10 kPa, and a specific power input of 0.2-3 W g⁻¹ product at the beginning of the drying process.

Statement 30. A method of any one of Statements 25-29, wherein drying comprises radio frequency drying, spray drying, freeze drying, drum drying, or vacuum drum drying process.

Statement 31. A method of any one of Statements 25-30, wherein milk cream comprises milk cream from a mammal.

Statement 32. A method of Statement 31, wherein the milk cream comprises milk cream from a cow, a goat, an ewe, a camel, a buffalo, a camel, or a human.

Statement 33. A method of any one of Statements 25-32, wherein the milk cream can be pasteurized, high heat treated, ultra-pasteurized, ultra-high temperature heat treated, or sterilized, or subjected to any other form of heat treatment, or any combination thereof.

Statement 34. A method of any one of Statements 25-33, further comprising adding an additive to the dehydrated milk cream either before drying or during any of the processing steps of Statements 25-33 or after microwave vacuum drying as dry blend.

Statement 35. A method of Statement 34, wherein the additive is a colorant, a sweetener, a salt, a flavoring, an emulsifier, fruits (e.g., a mixture of fruits), vegetables, and/or spices and/or other food preparations.

Statement 36. A method of any one of Statements 25-35, wherein milk cream is prepared by diluting high milk fat cream with skim milk.

Statement 37. A method of any one of Statements 25-36, further comprising cooling the homogenized milk cream for storage before evaporation and/or microwave vacuum drying.

Statement 38. A method for reconstituting a dehydrated milk cream product, the method comprising: obtaining a dehydrated milk cream product of any one of Statements 25-37; adding water to the dehydrated milk cream product in a ratio of 5:3 up to 20:17 w/w (water: dry cream), preferably 4:3 w/w (water: dry cream), to generate a premix solution; heating the premix to 50-80° C. and/or heating the water to 70-100° C. to achieve the desired temperature when mixed with the dried cream; blending the premix solution to generate reconstituted dried cream using a device that is capable to achieve local shear rates or gradients of at least 10⁻⁴ s⁻¹ and a power density of at least 10⁹ J m⁻³ to yield particles in the emulsion no larger than 20 μm in diameter and no large aggregates or clusters are present and preferably a mean volume-based average diameter d_{4,3} of 7-8 μm. Such devices can comprise a high shear mixer, single or multi-stage rotor-stator homogenizer or a colloid mill either in-line or batch; and cooling the blended premix solution to partially crystallize milk fat in cream.

Statement 39. A method of Statement 38, wherein the water is preheated to 75-92° C.

Statement 40. A method of Statements 38 or 39, wherein blending comprises blending in a kitchen blender (e.g., at 18,000-22,000 RPM) for 1-5 minutes.

Statement 41. A method of any one of Statements 38 or 39, wherein blending comprises blending with at rotor-stator mixer at 15,000-24,000 RPM for 1-5 min.

Statement 42. A method of any one of Statements 38, 39, or 41, wherein blending comprises blending with a rotor-stator mixer at 15,000-24,000 RPM for 1-5 min and subsequent homogenization at 0-3.5 MPa, 55-75° C.

Statement 43. A method of any one of Statements 38-42, further comprising adding an additive.

Statement 44. A method for reconstituting a dehydrated milk cream product, the method comprising:
adding water to the dehydrated milk cream product of any one of Statements 1-14 in a ratio of 5:3 up to 20:17 w/w (water: dry cream), preferably 4:3 w/w (water: dry cream), to generate a premix solution;
heating the premix to 50-80° C. and/or heating the water to 70-100° C. to achieve the desired temperature when mixed with the dried cream;
blending the premix solution to generate reconstituted dried cream using a device that is capable to achieve local shear rates or gradients of at least 10⁻⁴ s⁻¹ and a power density of at least 10⁹ J m⁻³ to yield particles in the emulsion no larger than 20 μm in diameter and no large aggregates or clusters are present and preferably a mean volume-based average diameter d_{4,3} of 7-8μ m.

Statement 45. A method of Statement 44, wherein blending comprises blending in a kitchen blender (e.g., at 18,000-22,000 RPM) for 1-5 minutes.

Statement 46. A method of Statement 44, wherein blending comprises blending with at rotor-stator mixer at 15,000-24,000 RPM.

Statement 47. A method of Statement 46, wherein blending comprises blending with a rotor-stator mixer at 15,000-24,000 RPM for 1-5 min and subsequent homogenization at 0-3.5 MPa and 55-75° C.

Statement 48. A method of any one of Statements 44-47, further comprising adding an additive.

The following examples are presented to illustrate the present disclosure. They are not intended to be limiting in any matter.

### Example 1

This example provides a description of one embodiment of the present disclosure.

A pasteurized liquid dairy cream having a fat content of 36% by mass is obtained. The dairy cream is then diluted with skim milk to a cream composition having a fat content of 30% by mass. The cream composition is then homogenized at a pressure of 7 MPa and a temperature of 65° C. to produce a homogenized cream composition. The homogenized cream composition is evaporated until the total solids are 43% by mass, producing an evaporated cream composition. These solids include both fat and non-fat solids. The evaporated cream composition is then subjected to microwave vacuum drying.

The microwave vacuum drying is performed in three stages. All of the stages are performed under a vacuum pressure of 25-35 mbar. In the first stage, a layer of liquid evaporated cream composition of 3 mm thickness is subjected to microwave radiation of 1.3 W per g of cream composition for a duration of 20 minutes. In the second stage, the cream composition is subjected to microwave radiation of 1.0 W per g of cream composition for a duration of 10 minutes. In the third stage, the cream composition is subjected to microwave radiation of 0.67 W per g of cream composition for a duration of 30 minutes.

At the conclusion of all three stages of microwave vacuum drying, the layer of cream composition will be dehydrated to a moisture content at or below 1.5% by mass and will have a fat content of greater than or equal to 78% by mass. This dehydrated cream product can be in the form of chips, flakes, powder, or pressed powder. This dehydrated cream product is shelf stable and resistant to spoilage for at least six months at room temperature.

The dehydrated cream product can be reconstituted to produce a reconstituted cream that features the whipping and churning functional properties of unprocessed heavy cream.

To reconstitute the dehydrated cream product, deionized water is preheated to 92° C. and combined with the dehydrated cream product to form a premixture. The amounts of dehydrated cream product and heater water are predetermined to produce a premixture with total solids of 43% by mass. The premixture is then subjected to high shear mixing in a rotor-stator mixer (e.g., UltraTurrax T25 equipped with a S25N—18 G dispersing tool) at 18,000 RPM (shear rate \dot{γ}=4·10⁴ s⁻¹) for 4 minutes. After high shear mixing, the mixture will cool to produce a reconstituted heavy cream.

The reconstituted heavy cream can be stored cold, under similar conditions to unprocessed heavy cream or other liquid dairy products (e.g., milk).

### Example 2

This example provides a description of one embodiment of the present disclosure.

A pasteurized liquid dairy cream having a fat content of 36% by mass is obtained. The dairy cream is then diluted with skim milk to a cream composition having a fat content of 30% by mass. The cream composition is then homogenized at a pressure of 1.8-7 MPa and a temperature of 60-75° C. to produce a homogenized cream composition. The homogenized cream composition is then optionally cooled and stored on ice. The homogenized cream composition is evaporated until the total solids are 36-50% by mass, producing an evaporated cream composition. These solids include both fat and non-fat solids. The evaporated cream composition is then subjected to microwave vacuum drying.

The microwave vacuum drying is performed in three stages. All of the stages are performed under a vacuum pressure of 25-70 mbar. In the first stage, a layer of liquid evaporated cream composition of 2-3 mm thickness is subjected to microwave radiation of 1.3 W per g of cream composition for a duration of 20 minutes. In the second stage, the cream composition is subjected to microwave radiation of 1.0 W per g of cream composition for a duration of 10 minutes. In the third stage, the cream composition is subjected to microwave radiation of 0.67 W per g of cream composition for a duration of 30 minutes.

At the conclusion of all three stages of microwave vacuum drying, the layer of cream composition will be dehydrated to a moisture content at or below 1.5% by mass and will have a fat content of greater than or equal to 80% by mass. This dehydrated cream product can be in the form of chips, flakes, powder, or pressed powder. This dehydrated cream product is shelf stable and resistant to spoiling for at least six months at room temperature.

The dehydrated cream product can be reconstituted to produce a reconstituted cream that features the whipping and churning functional properties of unprocessed heavy cream.

To reconstitute the dehydrated cream product, deionized water is preheated to 75-92° C. and combined with the dehydrated cream product to form a premixture. The amounts of dehydrated cream product and heater water are predetermined to produce a premixture with total solids of 43% by mass. The premixture is then subjected to high shear mixing in a rotor-stator mixer (e.g., Ultra Turrax T25 n equipped with a S25N—18 G dispersing tool) at 18,000 RPM (shear rate \dot{γ}=4·10⁴ s⁻¹) for 4 minutes. After high shear mixing, the mixture is optionally homogenized at a pressure between 0-3.5 MPa at a temperature of 65° C. The mixture will cool to produce reconstituted heavy cream.

The reconstituted heavy cream can be stored cold, under similar conditions to unprocessed heavy cream or other liquid dairy products (e.g., milk).

### Example 3

This example provides a description of one embodiment of the present disclosure.

A pasteurized liquid dairy cream having a fat content of 36% by mass is obtained. The dairy cream is then diluted with skim milk to a cream composition having a fat content of 30% by mass. The cream composition is then homogenized first at a pressure of 3.5-7 MPa and a temperature of 60-75° C. to produce a first homogenized cream composition. The first homogenized cream composition is then homogenized at a second pressure of 1.8-3.5 MPa at a temperature of 60-75° C. to produce a second homogenized cream composition. The second homogenized cream composition is evaporated until the total solids are 36-50% by mass, producing an evaporated cream composition. These solids include both fat and non-fat solids. The evaporated cream composition is then subjected to microwave vacuum drying.

The microwave vacuum drying is performed in three stages. All of the stages are performed under a vacuum pressure of 25-70 mbar. In the first stage, a layer of liquid evaporated cream composition of 2-3 mm thickness is subjected to microwave radiation of 1.3 W per g of cream composition for a duration of 20 minutes. In the second stage, the cream composition is subjected to microwave radiation of 1.0 W per g of cream composition for a duration of 10 minutes. In the third stage, the cream composition is subjected to microwave radiation of 0.67 W per g of cream composition for a duration of 30 minutes.

At the conclusion of all three stages of microwave vacuum drying, the layer of cream composition will be dehydrated to a moisture content at or below 1.5% by mass and will have a fat content of greater than or equal to 80% by mass. This dehydrated cream product can be in the form of chips, flakes, powder, or pressed powder. This dehydrated cream product is shelf stable and resistant to spoiling for at least six months at room temperature.

The dehydrated cream product can be reconstituted to produce a reconstituted cream that features the whipping and churning functional properties of unprocessed heavy cream.

To reconstitute the dehydrated cream product, deionized water is preheated to 75-92° C. and combined with the dehydrated cream product to form a premixture. The amounts of dehydrated cream product and heater water are predetermined to produce a premixture with total solids of 43% by mass. The premixture is then subjected to high shear mixing in a commercially available kitchen blender at 22,000 RPM for 3 minutes. After high shear mixing, the mixture will cool to produce reconstituted heavy cream.

The reconstituted heavy cream can be stored cold, under similar conditions to unprocessed heavy cream or other liquid dairy products (e.g., milk).

### Example 4

This example provides a description of one embodiment of the present disclosure.

Microwave vacuum drying (MVD) can lead to product structures and functionalities that cannot be achieved by traditional drying technologies. In this work, the potential of MVD for drying concentrated heavy cream was investigated.

Pasteurized heavy whipping cream was adjusted to 30% fat (35.5% total solids) with skim milk, either left unhomogenized, homogenized at 65-67° C. at 6.9 MPa (single-step) or at 6.9 MPa and 3.45 MPa (two-step). Homogenized cream was evaporated to 43% total solids in a rotary evaporator at 65-70° C. within 12 min and microwave vacuum dried using a pilot scale unit (nutraREV™, Enwave, BC, Canada) at 2 and 3 mm layer thickness, 1.5 W g⁻¹, and 27-37 mbar or 60-67 mbar. The moisture content, water activity, color, and free fat by solvent extraction of the dehydrated heavy cream were determined. The dehydrated heavy cream was reconstituted to 43% total solids (36% fat) at low shear in a blender and at high shear using a rotor-stator homogenizer. Reconstituted cream properties were investigated using color, optical microscopy, laser light diffraction, and confocal laser scanning microscopy. Whipped cream texture was determined using a Texture Analyzer equipped with a PC/R cream probe at 1 mm s⁻¹ pre-test speed, 2 mm s⁻¹ test speed, and 10 mm s⁻¹ post-test speed using the average force in N between 6 and 10 s at test speed. All experiments were conducted in triplicate and data was analyzed statistically.

A lower MVD pressure resulted in faster drying. Two-step homogenization led to a more cohesive dehydrated cream structure, lower free fat content (P<0.05), and different whipping properties. Single-step and two-step homogenization led to 0.84 N and 0.65 N foam strength, respectively, i.e., a significantly softer whipped cream structure (P<0.05) at 90 s whipping time than pasteurized whipping cream (2.97 N). However, longer whipping times of >3 min resulted in a foam strength >2 N for homogenized reconstituted whipped cream. Overall, the MVD drying conditions had a less significant effect on whipping properties as compared to the homogenization conditions and the reconstitution conditions.

These findings will be useful for dairy processors interested in adopting MVD as a versatile drying process for long life dairy product innovations.

### Example 5

This example provides a description of one embodiment of the present disclosure.

The present disclosure provides a process for producing shelf stable dehydrated heavy cream a with a shelf-life exceeding 6 months when stored in lightproof packaging at room temperature using gentle homogenization followed by microwave vacuum drying, and 2) creating a dehydrated cream product that can be easily reconstituted with water, either in a blender (household setting) or a rotor-stator homogenizer (industrial scale). The reconstituted dehydrated cream product maintains all the functionality of the initial heavy cream and allows for either direct utilization or consumption as heavy cream, or the production of whipped cream and butter.

Heavy cream and butter powders currently available on the marked are produced by spray drying. Defined standards in terms of minimum fat content do not exist and cream powders available on the market range from whole milk powders with increased fat content up to >80% fat. To avoid clogging up the spray dryer with very sticky high-fat power, a special spray drier design (e.g., FILTERMAT® dryer) and excessive homogenization of the cream are necessary. Due to excessive homogenization resulting in very small lipid droplets covered with a dense layer of protein, it is impossible to whip the reconstituted cream or churn it to butter. A very high surface area of the powder particles makes the powders prone to lipid oxidation and rancidity, limiting shelf life to a few months.

Existing products that match exactly the functionality of the microwave vacuum dried cream do not exist. Consumer products manufactured by spray drying that can be used to make a whipped product contain a long list of ingredients and vegetable fats (e.g., Dream Whip of the Kraft Heinz Company). However, producing fresh butter from this product is not possible.

Initial observations during preliminary experiments provided processing parameters relevant for optimization of the microwave vacuum drying process of cream. The parameters to optimize comprise: 1) pre-processing of cream at the right protein-to-fat ratio by homogenization to limit the viscosity increase and free fat formed during drying; 2) product layer thickness combined with to avoid brown spots; and 3) optimization of the drying conditions to achieve a sufficiently low moisture content and water activity while minimizing product temperature.

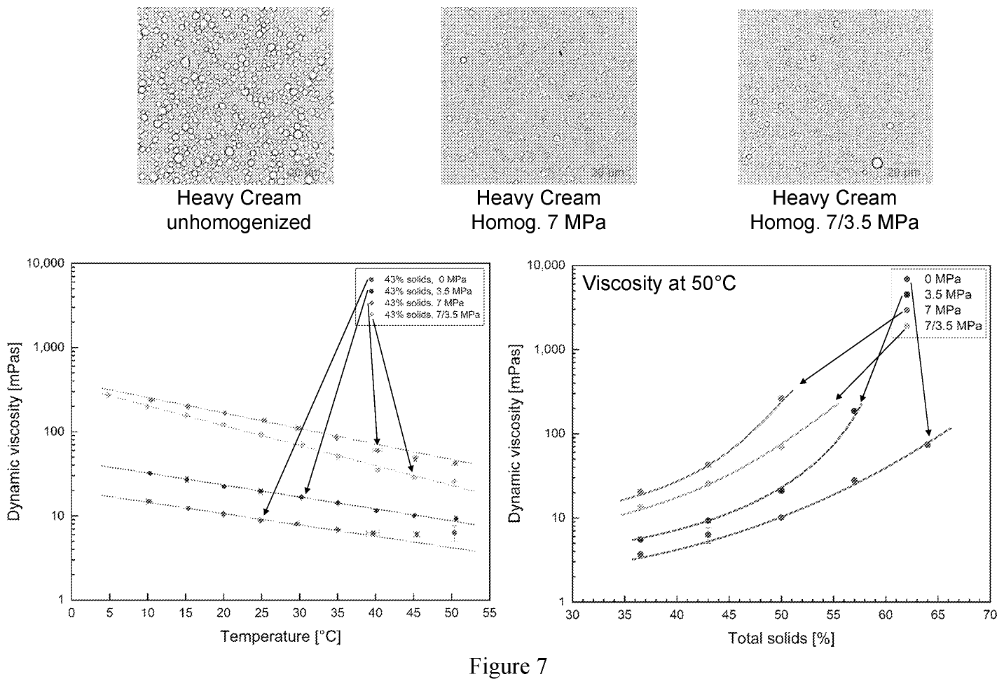

FIG. 7 shows homogenization of cream leads to a reduction in fat globule size as can be seen in the microscopy images (top) when comparing the unhomogenized and homogenized cream. Viscosity strongly increases with increasing homogenization pressure, while a two-step or two-stage homogenization at 7/3.5 MPa decreases viscosity due to the disruption of fat globule aggregates. The viscosity of cream and homogenized cream decreases with temperature. Evaporation of cream and homogenized cream increases the viscosity of cream due to the increase in the volume fraction of fat globules. Two stage homogenization is favorable, because it reduces the viscosity of cream over the entire temperature and total solids range. A lower viscosity allows the cream to be evaporated to higher total solids prior to drying to reduce energy consumption of processing.

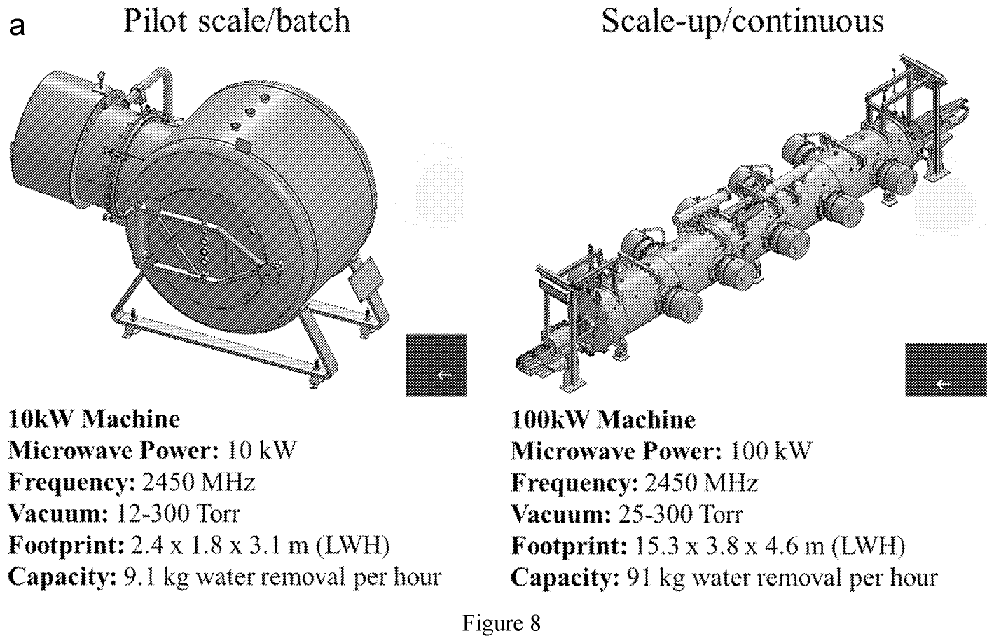

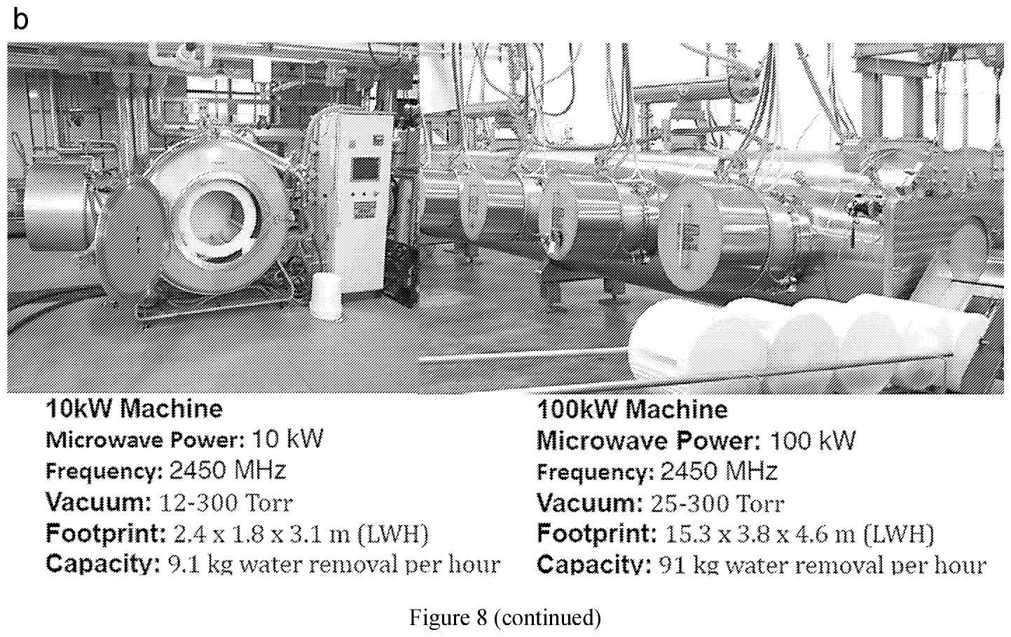

FIG. 8 shows the EnWave nutraREV™ commercial scale batch and continuous microwave vacuum drying systems, both as 3D CAD model and real-world installation.

Production capacity of the 10 KW batch MVD system for heavy cream at 43% total solids and a total drying cycle time including loading of 75 min would be 44 kg dry product per 24 hours if 5.4 kg of wet product are loaded per drying cycle.

Production capacity of a continuous 100 kW MVD system (90 kW power output) for heavy cream at 43% total solids, 20 hours operation per day, 1.67 kWh per 1.8 kg of wet product at 43% total solids would be 834 kg dry product from 1940 kg wet product per day.

Used herein were commercial pasteurized heavy whipping cream as a starting material. In preparation for the drying process, the cream was brought to the optimum fat and total solids level, and homogenized under different conditions, which affected the dry product structure as will be discussed later.

Cooling of the homogenized cream was done to further process the cream another day.

Evaporation of the homogenized cream is optional but can be done to reduce the energy consumption and cost for drying.

The next step is a key part of the process: microwave vacuum drying. For this, we are using a pilot scale microwave vacuum dryer made by the company Enwave, which is located in Geneva, NY.

The main components of the dryer are the drying chamber, which is the large cylindrical part in the center housing a carousel for the trays, the microwave generators (called magnetrons), located on the left-hand side of the drying chamber, and the vacuum generation system, located to the right. The large, tall cabinet on the far-right houses key electrical components and the control panel for the unit.

Processing parameters and preferred processing parameters:

1) Cream is adjusted to a fat content <32% fat before homogenization at pressures >3.5 MPa to limit the viscosity increase after homogenization due to cluster formation. The protein-to-fat ratio in higher fat cream and at higher homogenization pressures would be insufficient to cover the newly formed oil-water interface and result in excessive cluster formation after homogenization and a subsequent tremendous increase in viscosity. The MVD cream would most likely be very oily similar to MVD unhomogenized cream (not tested hypothesis). Possible fat content of cream before homogenization: 15-35% fat; Possible homogenization pressure: 1-10 MPa single stage, 1-10/0.5-8 MPa two-stage; possible homogenization temperature 50-85° C. Preferred fat content of cream before homogenization: 26-30% fat; Preferred homogenization conditions: 5-7/1.5-3.5 MPa two-stage; preferred homogenization temperature 65-70° C.

Homogenization before microwave vacuum drying is necessary to prevent the formation of free butter oil and a very sticky material at room temperature. It also facilitates the reconstitution process in hot water as the material can be dispersed more easily.

As a significant take-away, homogenization of cream before microwave vacuum drying affects the structure of the dry product and its reconstitution as well as its functional properties. Appropriate high-shear reconstitution combined with moderate homogenization before drying result in the coverage of fat globules with little protein. Such fat globules in cream exhibit similar whipping properties as native fat globules in pasteurized cream.

2) Cooling on ice after homogenization for proper storage is optional and not required if evaporation follows immediately.

3) Evaporation can be used to reduce the energy demand, i.e., cost, of the drying process and reduce drying time/increase output.

Possible total solids range for drying with and without evaporation: 30-65% total solids. Preferred total solids range for drying: 43-45% total solids (equivalent to 38-40% fat).

4) Microwave vacuum drying experiments in our experiments were performed in an EnWave nutraREV™ 10 kW batch MVD. Optimal conditions were determined using this batch drying system. An attempt was made to predict preferred and optimal conditions for continuous operation.

EnWave nutraREV™ batch drying system: Possible drying conditions: 0.5-3 W g⁻¹/1-10 kPa/30-90 min/feed temperature 2-55° C./layer thickness 0.5-4 mm. Preferred drying conditions: 1.2-1.3 W g⁻¹/2.8-4 kPa/20 min followed by 0.9-1.0 W g⁻¹/2.8-4 kPa/10 min followed by 0.5-0.67 W g⁻¹/2.8-4 kPa/30 min/feed temperature 10-15° C./layer thickness 2-3 mm.

EnWave continuous microwave drying system: Possible drying conditions: 0.5-3 W g⁻¹/1-10 kPa/30-90 min transport along the chamber/feed temperature 2-50° C./layer thickness 0.5-4 mm. Preferred drying conditions: 1.2-1.3 W g⁻¹/2.8-4 kPa/20 min transport along the chamber followed by 0.9-1.0 W g⁻¹/2.8-4 kPa/10 min transport along the chamber followed by 0.5-0.67 W g⁻¹/2.8-4 kPa/30 min transport along the chamber/feed temperature 10-15° C./layer thickness 2-3 mm.

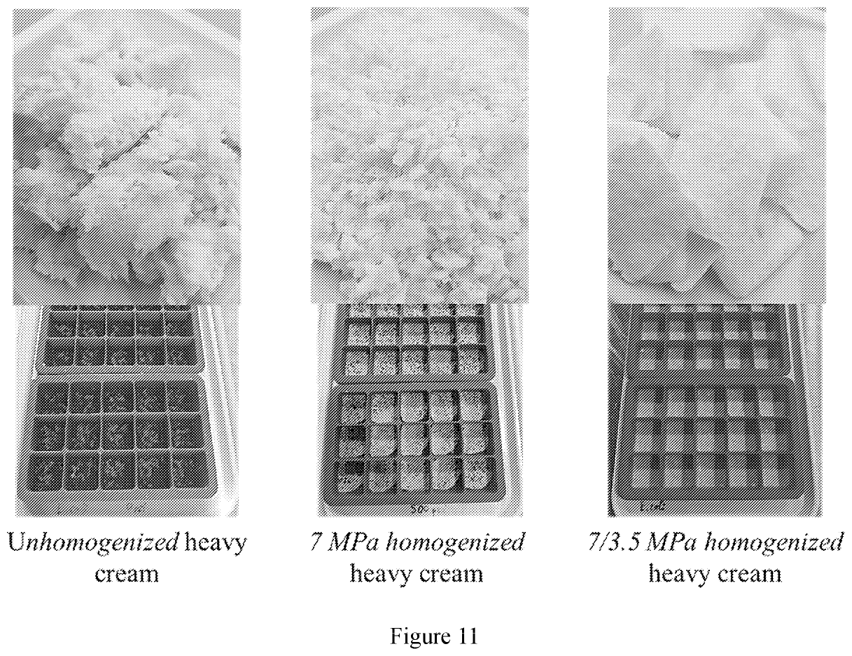

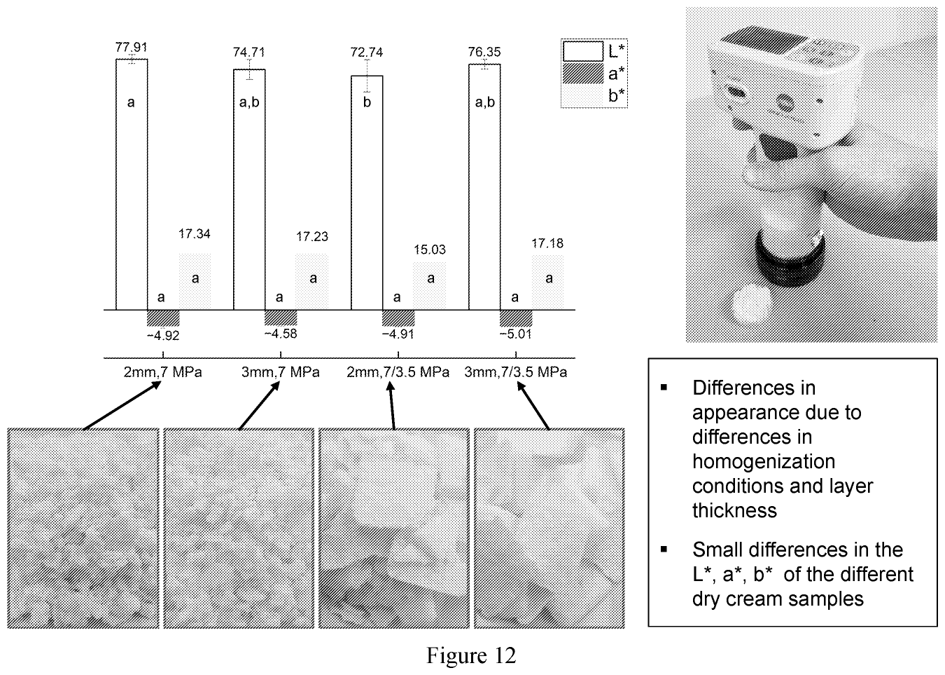

Desirable product properties of the MVD cream after drying: Water activity between a_{W}=0.1-0.35 corresponding to a moisture content of 0.5-1.5% w/w. Non-sticky, non-oily crumbly porous solid material (appearance defined in FIG. 12 by colorimetry and pictures in FIG. 11). Product temperatures exceeding 85° C. may lead to a very oily product and are not desirable.

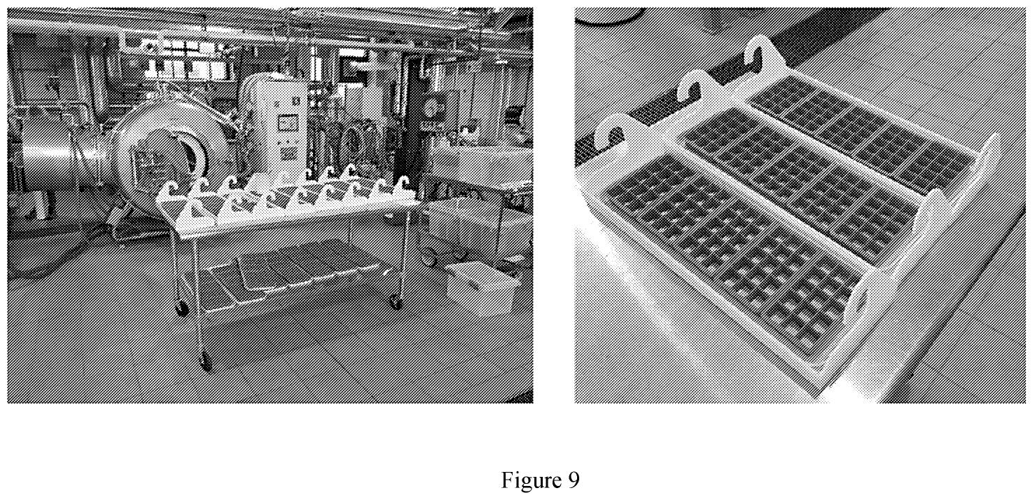

To dry the cream, or any other liquid, the product must be placed in the dryer in a thin layer of uniform thickness. In experiments using the Enwave nutraREV™ MVD and for research purposes, the cream was placed in blue silicone ice cube molds (FIG. 9). In a commercial manufacturing setting, a simpler solution like a horizontal rubber conveyor belt can be used for this. Once the cream is loaded in blue molds, they are placed onto these white plastic trays that are loaded one by one onto the carousel inside the microwave vacuum drying chamber. This manual loading process can be replaced by an automatic continuous loading process in a large scale, commercial semi-continuous or continuous system.

After all product has been loaded into the chamber, the front door is closed, and the process parameters which include microwave power, vacuum level and drying time are set on the controller.

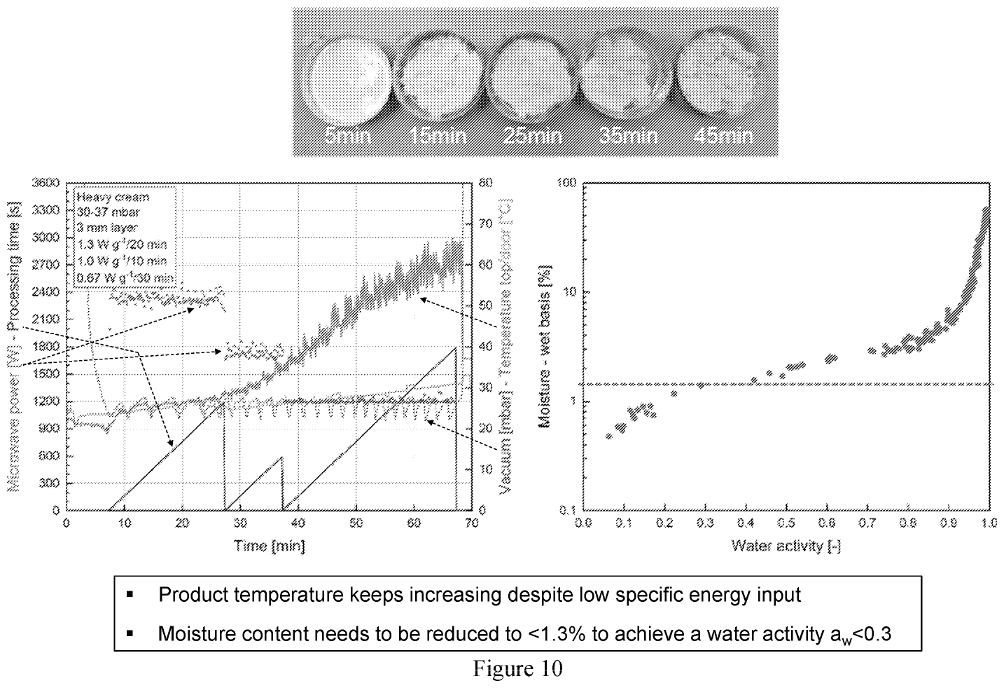

To assess the drying behavior of heavy cream, the drying rate, product temperature, and product properties i.e., moisture, water activity, product temperature as a function of chamber pressure, were assessed. Besides microwave power (see green dots in FIG. 10 (left)) and pressure (dotted purple line in FIG. 10 (left)), the temperature of the product is also shown (red line).

The specific power input was reduced over time to avoid overheating since the product moisture content decreases. This way, a 3-step drying process was developed. The product temperature could be limited to less than 85° C. to avoid a very oily product due to the separation of fat.

The product changes in appearance during drying. Starting from the left to the right (FIG. 10, top), cream with different solids levels is shown, after drying times of 5 min to 45 min. Cream changes gradually from a liquid through a pasty material to a solid material during drying. The desorption isotherm on the right shows that the moisture content needs to be reduced to 0.5-1.5% w/w which corresponds to a water activity of 0.1-0.35 to make the dry cream shelf stable.

What affects the color, product structure, appearance, and functionality of the final product is whether the cream was homogenized before the drying process. In FIG. 11, there are three types of dried product: unhomogenized cream on the left, single-step homogenized in the center and two-step homogenized to the right. The product looks differently even in the drying trays, but the differences are even more clear when we look at the product that has been taken out of the trays. On the left, the unhomogenized cream dries into a very oily, and when cooled down, pasty product, with a significant amount of free fat. The single stage homogenized cream leads to a brittle solid with some free fat that is shown in the middle, while the two-stage homogenized cream dries into nice, uniform porous chips on the right-hand side.

The drying process itself is very similar for cream and other dairy products such as concentrated skim milk. Appropriate drying conditions, product shape and distribution in the chamber prevent brown spots, uneven drying, and achieve a shelf-stable product.

Spray dried cream powders that are currently sold on the market lack any functionality for whipping or churning to produce whipped cream or butter. After reconstituting spray dried cream, it is not possible to use it to make whipped cream or churn it into butter. However, reconstituted microwave vacuum dried cream of the present disclosure can be used to make whipped cream or butter, similar to regular heavy cream-either at home or in a food industry setting.

Unique features of the product that differentiate it from dry cream produced by other drying technologies: chip-like structure and large pores inside the material (would not be present in a freeze-dried or vacuum drum dried product), chemical analysis (fat and protein content), flavor of the product, color values as presented on the following slide could help differentiate the product from products produced by other drying technologies.

Particle size or microscopy after reconstitution under controlled conditions provides insights into the pretreatment of cream by homogenization before drying. If cream at the specified fat content was left unhomogenized or homogenized in a way described for MVD, fat globules will be the same size as we determined it.

FIG. 12 shows differences in color between samples homogenized one-pass or two pass or microwave vacuum dried at different layer thickness were small despite the differences in appearance of the material. No differences could be detected in the a* and b* values while the L* values were significantly different which could be an effect of surface reflectivity.

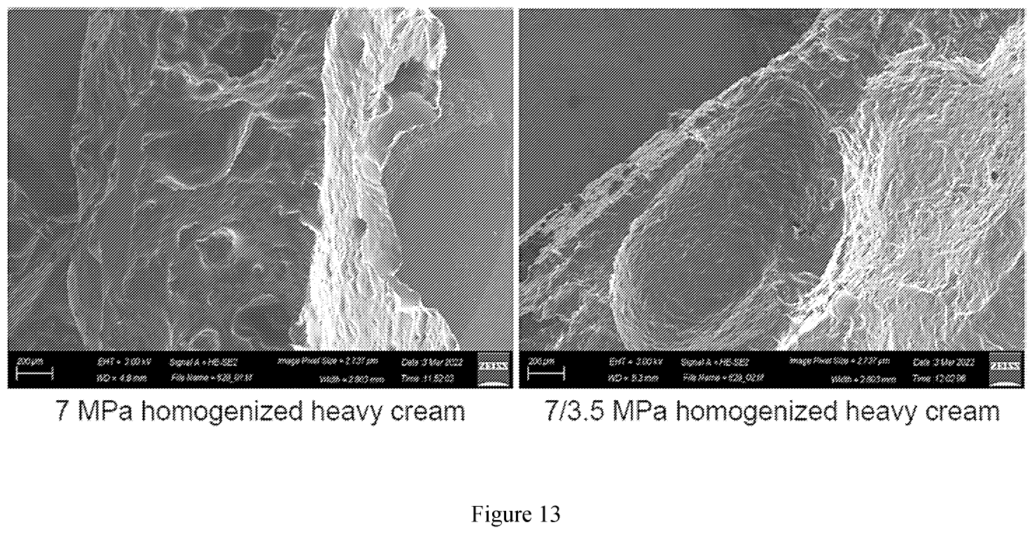

FIG. 13 shows SEM images of the microwave vacuum dried cream showed that homogenization before drying affected not only the macroscopic appearance of the dry material but also its microstructure. Samples homogenized single-stage/single-step at 7 MPa contained less pores inside the dense structure as compared to samples homogenized two-step at 7/3.5 MPa. Overall, the dried cream was not microporous, but dense, despite large air bubbles in the matrix. Individual fat globules were not visible on the surface.

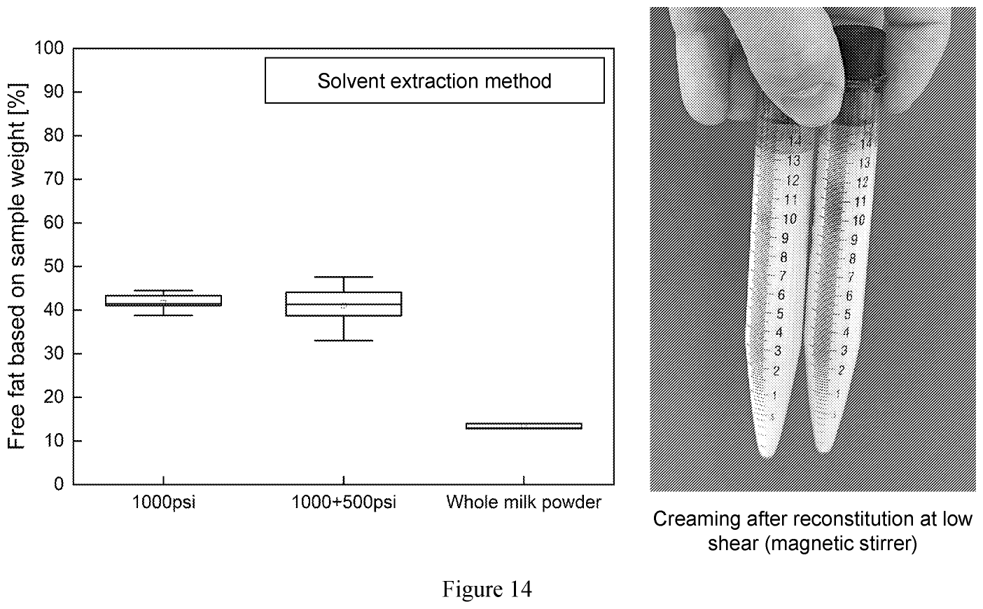

FIG. 14 shows the results of a common test for milk fat containing spray dried powder is the analysis of the amount of free fat, i.e., the amount of fat that can be extracted when the powder is dispersed in a non-polar solvent. The amount of fat extractable with solvent in microwave vacuum dried cream was compared with commercial spray dried whole milk powder in the plot on the left. It was seen that the percentage of extractable fat based on weight of the total sample was higher for the microwave vacuum dried samples. However, when the percentage of fat was calculated based on total fat, the percentage of extractable fat was about the same in whole milk powder and microwave vacuum dried powders. Reconstitution of microwave vacuum dried cream at low shear using a magnetic stirrer resulted in rapid creaming of fat clusters, but no free fat in the form of coalescing oil droplets was visible. In conclusion, the accessibility of fat in microwave vacuum dried cream is similar to whole milk powder, but reconstitution of the microwave vacuum dried material is not as simple as for whole milk or cream powder. Whole milk or cream powder can be dispersed in warm water by simple mixing.

To turn this material back into its original state, the microwave vacuum dried cream needs to be reconstituted with a high-shear mixing device. For reconstitution, hot water was added to the dry cream and either used a kitchen blender or a rotor-stator homogenizer at different shear and temperatures. Additional homogenization after reconstitution using a high-shear mixer could be used to yield smaller fat globules if needed to reduce creaming during storage of liquid cream but might compromise whipping and butter making properties.

Reconstitution conditions and preferred reconstitution conditions: Dehydrated cream/Microwave vacuum dried cream is reconstituted in hot deionized (DI) water to achieve a fat content sufficient for e.g., whipping or churning, using a high-shear mixing device. For whipping or churning, a minimal fat content or 30% is required. The maximum fat content for whipping and churning is given by the limit for pumping which is about 42% fat. Pre-mixing using low shear can facilitate the softening of the dry material before high-shear mixing.

Small scale household and large industrial scale equipment for reconstitution: High-shear mixer for the reconstitution of microwave vacuum dehydrated cream can be defined as any device that is capable to achieve local shear rates or gradients of at least 10⁻⁴ s⁻¹ and a power density of at least 10⁹ J m⁻³. Small household equipment that can achieve the desired shear gradients could be a blender, a food processor, a smoothie maker or similar device that uses a fast-rotating sharp blade. On laboratory scale, a high shear or also called rotor-stator homogenizer can be used. On larger or industrial scale, a high shear mixer, single or multi-stage rotor-stator homogenizer of larger dimensions or a colloid mill either in-line or batch can be used. Immediate high-pressure homogenization of the premix is impossible due to large particles likely to block the homogenizer inlet valve or homogenizer valve.

Reconstitution conditions and desirable product properties of reconstituted cream: Possible reconstitution conditions: DI-water or potable water at 70-100° C. is added to MVD cream (room temperature) in a ratio of 5:3 up to 20:17 w/w (water: dry cream), high shear mixing in above stated devices until all particles in the emulsion are no larger than 30 micron in diameter. No large aggregates or clusters should be present.

Preferred reconstitution conditions: DI-water or potable water at 75-92° C. is added to MVD cream (room temperature) in a ratio of 4:3 w/w (water: dry cream), high shear mixing in above stated devices until all particles in the emulsion are no larger than 20 micron in diameter and preferably a mean volume-based diameter of 7 μm.

Additional high-pressure homogenization after reconstitution using a high-shear mixer could be used to yield smaller fat globules if needed to reduce creaming during storage but will compromise whipping and butter making properties.

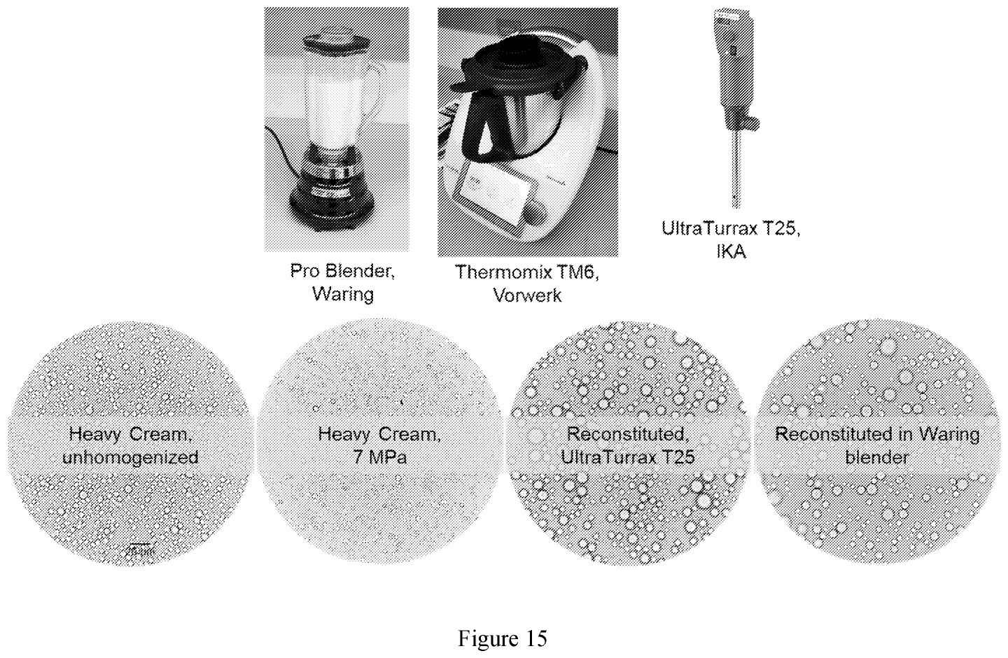

FIG. 15 shows high-shear mixing devices for reconstitution of microwave vacuum dried cream that were employed are shown in these pictures. A Waring blender, a Thermomix®, which is a temperature-controlled blender, and an Ultra Turrax T25 rotor-stator homogenizer were used. The microscopic images below show—from left to right—the fat globules present in unhomogenized heavy cream and single stage homogenized heavy cream for comparison. On the right, reconstituted microwave vacuum dried cream using the UltraTurrax T25 and the Waring blender is shown. The microscopic images show that reconstituted cream contains larger fat globules than originally present in heavy cream, but no clusters or aggregates.

Reconstitution of the dry cream in a blender, which could be done easily in any home. Three cups of dry cream were put in the blender, 2 cups hot water were added, and the blender was operated at the highest speed for 3 to 4 minutes. After cooling of the reconstituted cream, a thick heavy whipping cream is obtained.

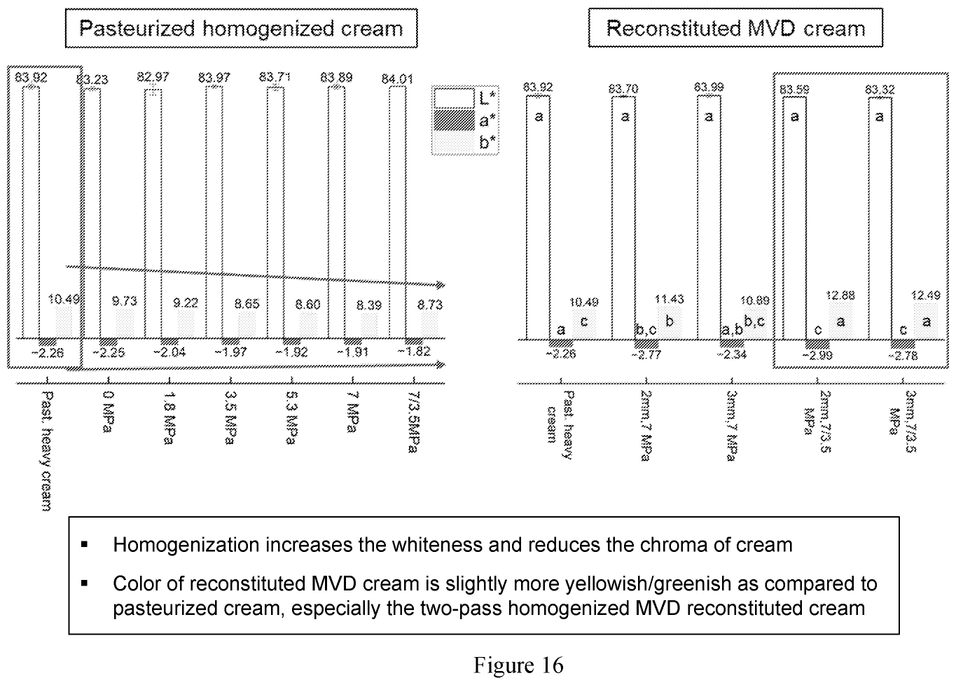

FIG. 16 shows the color of pasteurized cream and homogenized cream as a reference here shown on the left changes with increasing homogenization pressure. The L* value remains constant while the absolute values of a* and b* decrease which corresponds to a decrease in the yellowish and greenish hue of cream. Hence, cream appears whiter after homogenization.

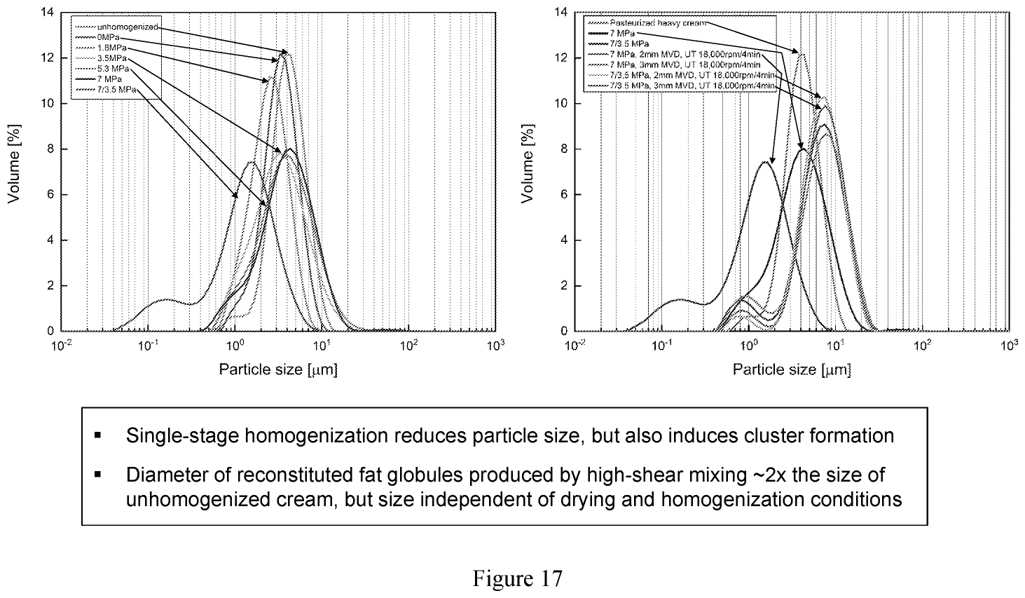

FIG. 17 shows a more microscopic view on the particle size of homogenized cream vs. pasteurized cream and reconstituted cream confirmed observations from microscopy and color measurements. Single-stage homogenization reduces particle size, but also induces cluster formation. A broadening of the size distribution is the consequence. Two-step homogenization notably reduces the fat globule size as seen in the graphs on the left. Two-step or two-stage homogenization disrupts the clusters formed during the first pass through the homogenizer valve. FIG. 17 (right) shows a comparison of the particle size distribution between pasteurized cream, single-stage and two-step homogenized cream, and the 4 different reconstituted cream samples using the UltraTurrax rotor-stator homogenizer. A similar size distribution of reconstituted cream samples shows that the reconstitution conditions determine the fat globule size distribution, not the homogenization and/or drying conditions.

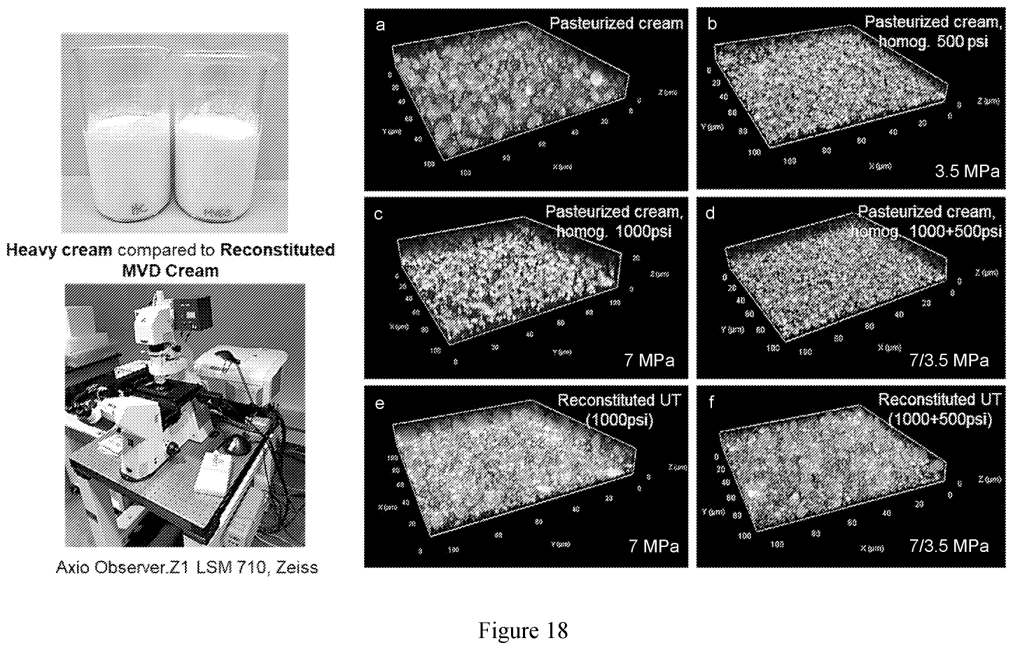

The image on the upper left-hand corner in FIG. 18 shows that the visual appearance of pasteurized cream and reconstituted cream were very similar, and it was hard to tell which is which despite the difference in particle size. To learn more about the microstructure of cream and explain similarities and differences in the whipping properties, confocal laser scanning microscopy (CLSM) was used. Using CLSM, it is possible to differentiate between fat (red) and protein (green) in cream, by staining them in different colors, and thereby obtain spatial information about the distribution of fat and protein in 3D. In these images, a comparison between pasteurized heavy cream (top left) and different homogenized samples is shown in the first four images to demonstrate the effect of homogenization on the distribution of fat and protein with increasing homogenization intensity. More intense homogenization leads to more protein (green) at the newly created oil-water interface and smaller fat globules. By contrast, the fat globules in reconstituted cream in the CLSM images at the bottom appear somewhat bigger and covered by more protein than in pasteurized heavy cream. More protein on the fat globule surface is an effect of processing, but a lot less covered by protein than in homogenized cream. Differences in protein coverage of fat globules and size distribution might explain the similar functionality (whipping, churning) of reconstituted cream and pasteurized cream as compared to homogenized cream.

It was found that the consistency of whipped cream obtained from reconstituted cream is very close to the consistency of the pasteurized whipped cream.

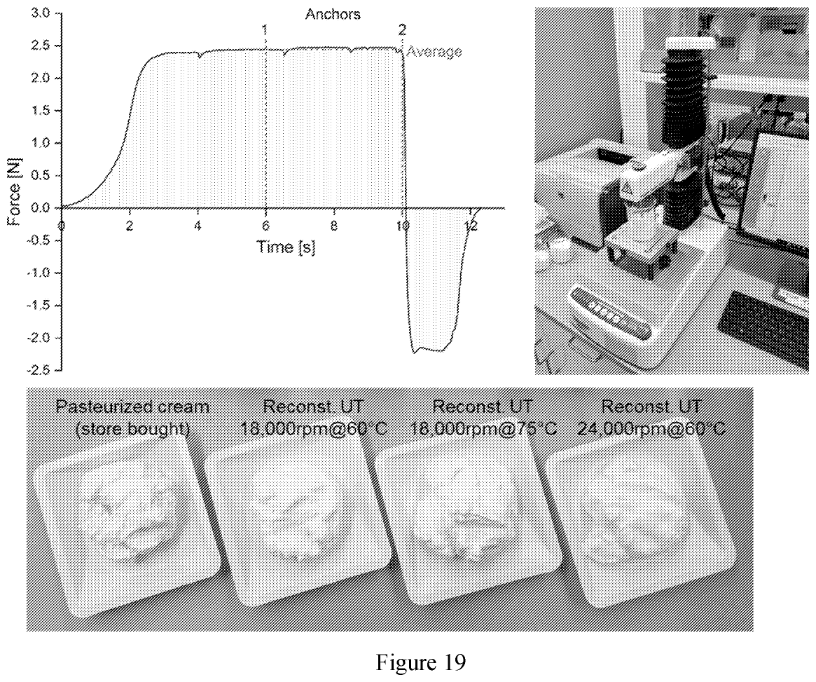

Shown in FIG. 19 is a side-by-side comparison of whipped cream obtained from regular pasteurized cream (on the left) and whipped cream reconstituted under different conditions using the UltraTurrax high shear rotor-stator homogenizer (the 3 samples to the right). The results obtained could be explained by similarities in the microstructure of pasteurized cream and reconstituted cream.

To confirm these visual observations, the texture of the whipped cream was determined using a Texture Analyzer fitted with a cream testing probe. The Texture Analyzer essentially the resistance of the whipped cream when the probe penetrates it. This provides the whipped cream firmness.

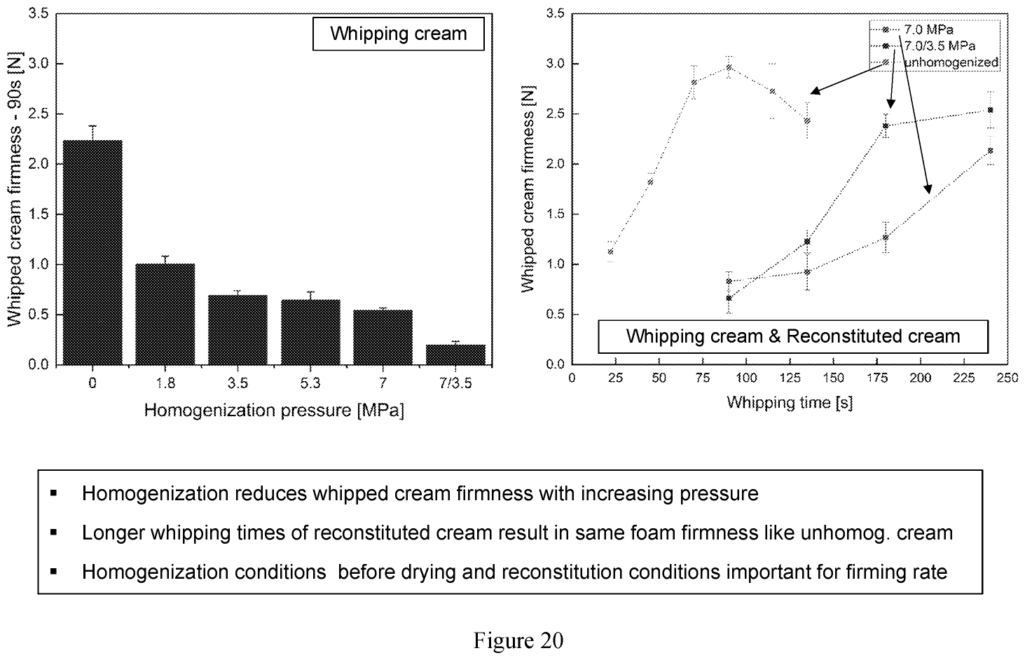

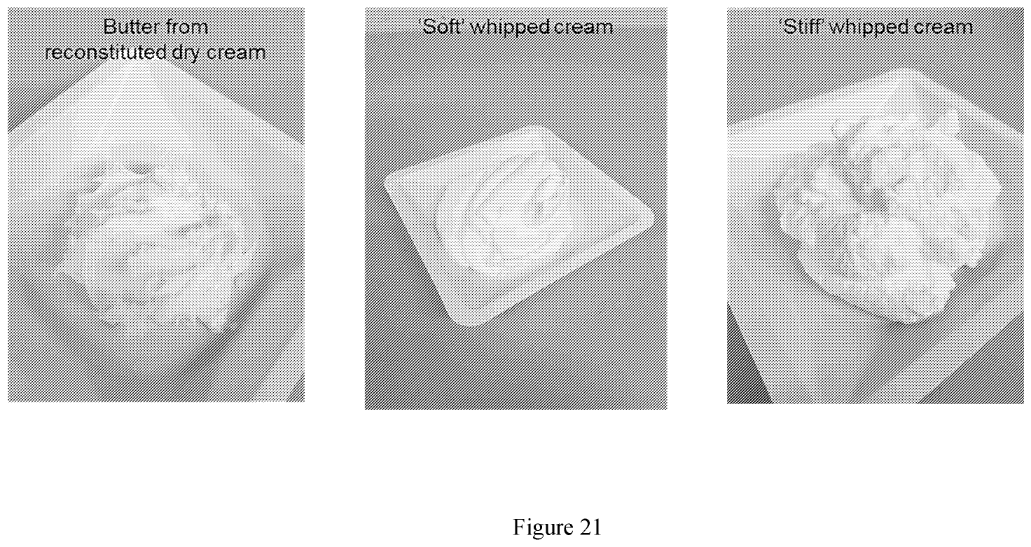

To better understand and compare whipped cream firmness of reconstituted microwave vacuum dried cream, pasteurized cream was compared at single stage and two-step homogenized cream at different pressure. In FIG. 20, the chart on the left shows that increasing homogenization pressure, reduces whipped cream firmness at 90 seconds whipping time. This is a result of smaller fat globules less sensitive to shear and the oil-water interface being increasingly covered by protein as we had seen. Unhomogenized cream as shown in the green graph on the right shows a fast firming rate and a peak firmness at 90 seconds. Whipping of reconstituted microwave vacuum dried cream takes about twice as long as the firming rate is slower, probably due to more protein at the oil-water interface that stabilizes the fat globules. However, the same final firmness as compared to pasteurized cream can be achieved.

Microwave vacuum dried shelf stable cream could either be reconstituted at home as a B2C product using a blender or on industrial scale (B2B) using rotor stator-homogenizers to preserve milk fat without refrigeration for several months and preserve its functionality.

The reconstituted heavy cream can be whipped or churned to obtain whipped cream or butter, respectively. This whipped cream or butter can be used in the same way as those produced from regular cream either in a household setting, gastronomy, or in industry.

Using the reconstituted cream as a replacement of regular heavy cream as coffee creamer, for cooking, baking, or any other food applications.

The dehydrated cream of the present disclosure could be used in consumer products or ingredient for industry, which allows the long-term storage of milk fat at ambient conditions, after which it can be converted to heavy cream by simple reconstitutions with water and use for various purposes.

Potential modifications to the present disclosure include: 1) Radio frequency vacuum drying, vacuum drying (conductive or radiative heat transfer), or vacuum drum drying (conductive heat transfer) as an alternative to microwave vacuum drying, 2) Reconstitution in different high shear mixing devices, 3) Homogenization (after reconstitution in a high shear mixing device) to increase the storage stability of reconstituted dehydrated cream, and 4) Further pasteurization or UHT heat treatment of the reconstituted dehydrated cream and packaging for sale (e.g., in countries with limited milk supply).

Depending on the homogenization conditions before drying and the reconstitution conditions after drying as well as the whipping conditions, the whipped cream can have either a soft or a stiff consistency.

### Example 6

This example provides a description of one embodiment of the present disclosure.

Traditional ways to preserve cream involve processing into butter, butter oil, or frozen storage. These technologies do not preserve the unique functionality of cream with respect to whipping or processing into butter. In this work, microwave vacuum drying (MVD) was investigated as a method to manufacture dehydrated cream. Dehydrated cream microstructure, color, and free fat were evaluated using scanning electron microscopy, colorimetry, and solvent extraction, respectively. Effects of homogenization on reconstituted cream microstructure and functionality were investigated using confocal laser scanning microscopy, color, particle sizing, and texture analysis of whipped cream. Reconstituted MVD cream whipped faster, and the whipped cream was more cohesive and firmer when two-step homogenization at 3.5/7 MPa was used. Fat globules in reconstituted MVD cream were covered by phospholipids, explaining MVD cream's similar functionality compared to pasteurized cream. These results may foster the development of novel shelf stable and highly functional dairy products using MVD.

Described herein is the determination of the effects of pre-processing, drying, and reconstitution conditions on the functionality of reconstituted MVD cream. Physical properties and the microstructure of fat globules, before drying, after drying, and after reconstitution, were investigated and used to explain the impact of the various processing steps on the MVD cream functionality. Linking the effects of pre-processing and product microstructure of fat containing dairy products with their drying behavior under vacuum using microwaves as a heat source, dry product structure, reconstitution properties, and functionality will help unleash the potential of MVD for a broad range of dairy products, including cream and cheese.

Homogenization, evaporation, and determination of evaporated cream viscosity. Pasteurized heavy cream was purchased from local grocery stores (Ithaca, NY, USA). Cream was diluted to 36±0.3% total solids using pasteurized skim milk to achieve a fat content of 30%. After heating to 65-67° C. the cream was homogenized at 1.8, 3.5, 5.3, and 7 MPa or 7 MPa in the first pass and 3.5 MPa in the second pass using a FT-9 single-stage bench-top homogenizer (Armfield Ltd, Ringwood, UK). The latter two homogenization conditions were used for all cream subjected to MVD. After homogenization, the cream was rapidly cooled to <10° C. in ice-water and stored under refrigeration at <5° C. until further processing.

Homogenized cream was then evaporated to about 43.5% total solids at 65-70° C. (20-25 kPa) using a rotary evaporator (Büchi, Flawil, Switzerland) and immediately cooled in ice-water. Small amounts of DI-water were added as needed to adjust the solids content to 43.5% total solids.

Viscosity of homogenized cream with and without further evaporation was determined as a function of temperature and total solids content using a ViscoQC-300L (Anton Paar, Graz, Austria) equipped with a L1, L2, or L3 spindle, depending on the expected viscosity, and a 250 mL double-jacketed beaker (ø=54.5 mm) connected to a thermostatically controlled water bath.

Microwave vacuum drying of cream. A small commercial-scale EnWave nutraReV™ 10 KW microwave vacuum drier (EnWave Corporation, Delta, BC, Canada) was used to carry out the drying experiments, as described by Dumpler and Moraru (2022b). A total of 40 ice cube trays were placed on the carousel in the drying chamber. Volumes of 2 or 3 mL of evaporated cream were pipetted using a Multipette M4 (Eppendorf AG, Hamburg, Germany) into each cavity of the 40 silicone ice cube trays, having 15 cavities each of 3.2×3.2×3 cm (L×B×H). The resulting cream layer thickness was 2 or 3 mm in each cavity. In total, 1200 or 1800 mL of evaporated cream were distributed in the 600 cavities. Drying conditions were determined in preliminary trials. A three-step process was developed based on the three drying stages of cream. It was intended to achieve a fast drying in the first and second drying stage while limiting the maximum product temperature in the last drying stage to <65° C. An example of a PLC recording is shown in FIG. 10 (left). Product temperatures exceeding 65° C. led to leakage of butter oil from milk fat globules in the dried cream, i.e., a very oily, sticky product of dispersed milk solids in butter fat (not shown). The drying conditions were 1.3 W g⁻¹ for 20 min, 1.0 W g⁻¹ for 10 min followed by 0.67 W g⁻¹ for 30 min at 2.2-2.8 kPa. The pressure, microwave power and time settings of the MVD unit were adjusted to the required values at the human machine interface (HMI) of the programmable logic controller (PLC). The rotation speed of the carousel was set to 35% (˜3 rpm, 360° rotation) in all experiments.

Moisture, water activity, color, extractable fat, and fat content: The moisture content of the initial cream, homogenized cream, evaporated cream, and dehydrated cream was determined using a CEM Smart Turbo 5 (CEM, Matthews, NC). Water activity of dehydrated cream was determined using a AquaLab 4TE (METER Group, Pullman, WA). Color of dehydrated cream and reconstituted cream was determined using a CR-400 colorimeter (Konica Minolta Sensing Americas Inc., NJ) equipped with a Granular Materials Attachment CR-A50 to shield sunlight. All measurements were performed at least in triplicate.

Extractable fat of dehydrated cream samples was determined by the solvent extraction method. In brief, 10 g of sample were weighed in a 125 mL Erlenmeyer flask, 50 mL of petroleum ether (boiling point 20-40° C.) was added, and extraction was performed for 15 min at ambient temperature with a magnetic stirrer bar. After extraction, the extract was transferred to a 75 mm glass funnel lined with a 597 H ½ 125 mm folded filter (Cytiva, Marlborough, MA) on top of a tared 100 mL flask. The extract and suspended solids were transferred quantitatively by rinsing the flask with another 25 mL petroleum ether. After filtration, the solvent was evaporated with slight vacuum in a gentle flow of air using the rotary evaporator described above. The extracted butter oil and flask were dried in oven at 104-106° C. for 30 min. After cooling the flasks in a desiccator for at least 30 min, the flasks were weighed. The percentage of extractable butter fat was calculated from the amount of extractable fat divided by the total fat in the total sample.

Total fat after HCl digestion was determined by weighing 0.75 g of dehydrated cream in a XT4 filter bag and adding 0.75 g of diatomaceous earth. Prepared samples were hydrolyzed in a sealed Teflon vessel in batches of 15 using 6 N HCl in an ANKOM^{HCl} Hydrolysis System (ANKOM Technology, Macedon, NY) for 60 min. After acid hydrolysis, solvent extraction (45% petroleum ether, 45% diethyl ether, 10% ethanol) was performed with solvent at 90° C. for 60 min using the ANKOM^{XT15} Extractor. Total Fat content determined by loss of weight. A commercial whole milk powder sample was used as a reference.

Scanning electron microscopy: Dehydrated cream was attached to a sample holder with silver conductive paint 503 (Electron Microscopy Sciences, Hatfield, PA) and carbon sputtered using a Desk V high vacuum magnetron sputter unit (Denton Vacuum, Moorestown, NJ) for 30 s. Scanning electron micrographs of dehydrated cream were obtained using a Zeiss Gemini 500 scanning electron microscope (Zeiss, Oberkochen, Germany) at 3 keV and low magnification mode.

Reconstitution of dehydrated cream: Dehydrated cream was reconstituted using a S25N—18 G dispersing tool attached to an UltraTurrax T25 rotor-stator homogenizer (IKA® Works, Inc., Wilmington, NC) by adding 224 g of DI-water at 92° C. to 172 g dehydrated cream. Reconstitution was performed in an insulated 600 mL beaker to yield a total solids content of 43% total solids in the reconstituted cream under conditions optimized in preliminary trials. Preliminary trials at different mixing temperatures ranging from 45 to 75° C., 12,000 to 24,000 rpm, and reconstitution times ranging from 0.5 to 6 min had shown that 18,000 rpm (calculated shear rate \dot{γ}=4·10⁴ s⁻¹) for 4 min at 61-64° C. were the minimum shear, time, and temperature needed to obtain a stable emulsion without any aggregates or lumps.

Particle size analysis: Particle size of pasteurized cream, homogenized cream, and reconstituted cream was determined by laser light diffraction/static light scattering (SLS) using a Malvern Mastersizer 2000 equipped with a Malvern Hydro 2000 G sample dispersion unit (Malvern Panalytical Ltd, Malvern, UK). Equal amounts of cream samples were dispersed in warm DI-water to break up clusters bridged by free solid fat before adding the diluted cream to the sample dispersion unit until a laser obscuration between 10 and 20% was reached. The refractive index of the dispersant (DI-water) was set at 1.33 and the refractive index for milk fat was set at 1.458 for the red laser (633 nm) and 1.460 for the blue laser (466 nm) (Michalski et al., 2001). Particle absorption index was set to 0.0001. Pump speed was set to 1,000 rpm, stirrer speed to 850 rpm, and continuous ultrasonication at 20% tip displacement. Three independently dried and reconstituted samples were measured. Each sample was measured in duplicate at 25° C. in DI-water with two 12 s runs per aliquot.

Confocal laser scanning microcopy: Stain solutions for confocal laser scanning microscopy (CLSM) were prepared by dissolving Nile Red (Sigma-Aldrich, Burlington, MA), a lipophilic fluorescent probe, at a concentration of 1 mg mL-1 in 100% acetone. Fast Green FCF (Sigma-Aldrich, Burlington, MA) as dissolved at 1 mg mL-1 in DI-water to stain proteins. The fluorescent phospholipid analogue Rd-DOPE (1,2-dioleoyl-sn-glycero-3-phosphoethanolamine-N-(lissamine rhodamine B sulfonyl) was purchased as solution at 1 mg mL⁻¹ in chloroform (Avanti Polar Lipids, Croda Inc., Plainsboro, NJ).

An aliquot of 150 μL cream, homogenized cream, or reconstituted microwave vacuum dehydrated heavy cream was mixed with 820 μL warm DI-water preheated to 70° C. for dual-stained samples or 835 μL for single-stained samples and vortexed in a 1.5 mL sample vial. Subsequently, samples were single-stained with Rd-DOPE (1:100 v/v) or dual-stained with Nile Red (1:100 v/v) and Fast Green FCF (1:100 v/v). After addition of 15 μL Fast Green FCF, samples were vortexed, subsequently 15 μL Nile Red were added, and samples vortexed. For single stained samples, 15 μL Rd-DOPE were added to diluted cream and vortexed. Stained samples were incubated at least 30 min in the dark at room temperature and shaken from time to time to prevent phase separation. For fixation of stained fat globules in cream, 1% agarose solution was heated to 95° C. in water bath to melt the gel. After solubilization, 500 μL of 1% agarose was quickly added to the stained samples, shaken, and vortexed. An aliquot of 15 μL of the liquid mixture was quickly transferred to a large cover glass (#1.5, 0.175 mm thickness, 24×50 mm B×W). A coverslip (#1.5, 0.175 mm thickness, 18×18 mm B×W) was immediately placed on top of the sample. The assembly was quickly transferred to a 12 mm aluminum plate on crushed ice for rapid cooling and gelling to prevent phase separation, evaporation, and thinning of the liquid layer between the slides due to capillary pressure that would squeeze the fat globules. Samples were checked under an AxioLab.A1 light microscope (Carl Zeiss, Oberkochen, Germany) for homogeneity and stored in petri dishes next to a wetted sponge to prevent drying of the gel layer. Confocal imaging was performed within 5 h after fixation.

An inverted confocal laser scanning microscope LSM 710 Axio Observer.Z1 (Zeiss, Oberkochen, Germany) was used to image the milk fat globule samples with a plan-apochromat 63×/1.40 Oil DIC objective. Excitation of Fast Green FCF was achieved with the 633 nm laser line and the emitted light was collected between 647 and 758 nm. Nile Red was excited with the 488 nm laser line and the filters were set to collect the emitted light between 555 and 646 nm. Samples stained with Rd-DOPE were excited with the 561 nm laser line and the emitted light was collected between 555 and 724 nm. 3D images were obtained by scanning the sample in the z-axis in steps of 0.4 μm. Images were analyzed using the Zeiss Zen blue software.

Whipping properties of reconstituted cream: An aliquot of 200 g of cream was poured in a 600 mL insulated beaker, adjusted to 4.9-5.2° C., and whipped for defined times at level 4 using a Sunbeam® hand mixer. Heavy cream from the store or reconstituted dehydrated cream were stored for at least 3 days at 3-4° C. before use. About 100 mL whipped cream was transferred to three 250 ml beakers. A P/CR cream probe developed by Pichert (1979) was attached to a TA-XT Plus Texture Analyzer (Stable Micro Systems, Surrey, UK). Texture analyzer settings were: compression mode, pre-test speed 1.0 mm s⁻¹, test speed: 2.0 mm s⁻¹, post-test speed: 10.0 mm s⁻¹, distance 20 mm, trigger force 0.020 N. Penetration force in Newton was averaged between 6 and 10 s to determine whipped cream firmness. Measurements were performed in triplicate.

Statistical analysis. A one-way ANOVA followed by a Tukey test was used to determine significant differences among L*, a*, b* color values of dehydrated cream and reconstituted dehydrated cream. Statistical data analysis and plotting was performed using OriginPro 2022b.

Viscosity of homogenized and evaporated cream. Pasteurized cream was diluted to 30% fat to limit the viscosity increase after homogenization. The protein-to-fat ratio in higher fat cream (<0.075 g protein/g butter fat) would be insufficient to cover the newly formed oil-water interface, especially at higher homogenization pressures than 7.5 MPa. A lower protein-to-fat ratio would result in excessive cluster formation after homogenization and a subsequent tremendous increase in viscosity. FIG. 7 shows the effect of homogenization conditions and temperature on cream viscosity, concentrated from 36 to 43% total solids (FIG. 7, left), and the effect of evaporation on viscosity at 50° C. (FIG. 7, bottom right). A temperature of 50° C. was chosen to demonstrate viscosity trends as this could be the temperature in the last stage of an evaporator. Cream viscosity decreased strongly with increasing temperature and increased with increasing homogenization pressure up to 7 MPa. A second pass at 3.5 MPa reduced the viscosity of cream due to the disruption of clusters. Increasing temperature reduced homogenized cream viscosity which can help increase the maximum possible total solids content of homogenized cream concentrate before MVD. FIG. 7 (right) shows that viscosity strongly increased with increasing total solids content. Nevertheless, cream can be evaporated to >45% total solids at 50° C., while remaining free flowing at a viscosity <100 mPas. A high product viscosity can hamper the fast evaporation of water, which is necessary to reduce the energy demand for drying. In preliminary experiments, it was found that moderate homogenization of cream before MVD improves the stability of fat globules against coalescence during drying, caused by very close packing of the globules. Coverage of the small fat globules with a dense and thick layer of protein prevents the separation of liquid butter oil from the other milk solids. However, an increase in viscosity is inevitable when cream is homogenized due to cluster formation, the decrease in the interparticle distance between fat globules, and the rearrangement of phospholipids and protein at the oil-water interface. In cream, this increase in viscosity becomes more pronounced with increasing homogenization pressure. The limited availability of protein to cover the newly formed oil-water interface in high-fat emulsions like cream leads to fat cluster formation. Two-stage homogenization or a second pass at a lower homogenization pressure can reduce the viscosity of homogenized cream due to the disruption of the clusters formed during the first pass.

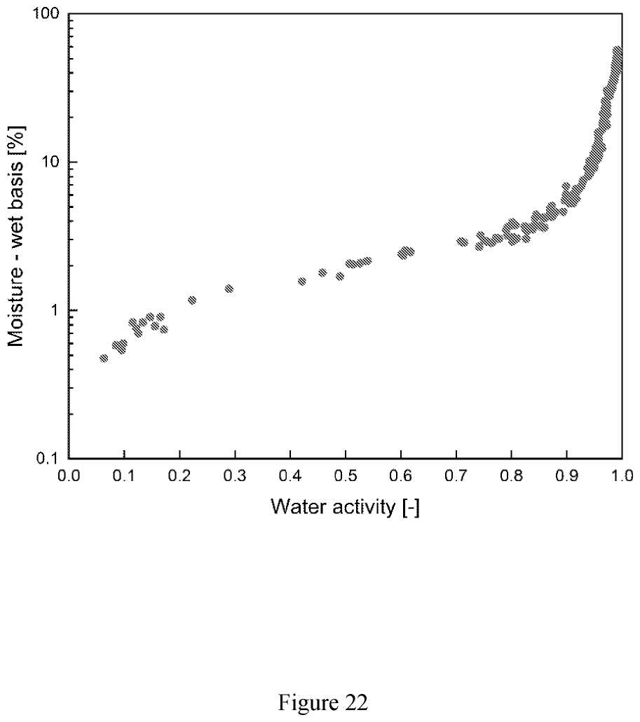

Desorption isotherm of dehydrated cream. Limiting chemical reactions like Maillard browning and lipid oxidation to achieve a long shelf life is an important characteristic of dairy powders. To limit such reactions in dehydrated cream, a water activity of 0.2-0.3 is required. In dehydrated cream containing more than 78% fat as obtained in this study, little water binding solids are available. According to the cream moisture sorption isotherm in FIG. 22, a moisture content of 0.5-1.5% w/w, corresponding to a_{W}=0.1-0.35, needs to be achieved to ensure shelf stability.

Color, structure, and microstructure of dehydrated cream. Homogenization affected the visual appearance of dehydrated cream. Single-step 7 MPa homogenized cream yielded a brittle and slightly oily dry material after MVD, which formed small flakes when removed from the ice cube molds as shown in the pictures in FIG. 12, left. Layer thickness had little effect on the visual appearance of the dry material. Two-step homogenized cream at 7/3.5 MPa yielded a cohesive material that appeared as chips when removed from the molds. Cream layers of 3 mm produced thicker dehydrated cream chips than 2 mm layers. Visual appearance was determined by cream homogenization conditions. Overall, the L* a* b* color values of dehydrated cream did not show major differences while the L* values were significantly different (FIG. 12, left). However, this difference was neither correlated to layer thickness nor homogenization pressure. Differences in L* values may be related to the surface reflectivity of samples.

Scanning electron microscopy (SEM) images of a cross-section of a chip of MVD dehydrated cream produced from cream homogenized at 7 MPa and 7/3.5 MPa are shown in FIG. 13. These images revealed that the microstructure of MVD cream is very dense, individual fat globules could not be distinguished, and no micropores were visible. The dry material appeared like a homogeneous matrix indicating that fat globules partially or completely merged into a continuous matrix when water evaporated during drying. Some intact fat globules could be embedded in a continuous matrix of butter fat, although these images did not capture such instances. A more porous structure and larger number of large pores were observed in chips of dehydrated cream produced from cream homogenized at 7/3.5 MPa as shown in FIG. 13 (right). This could be a result of stronger cohesion of the dehydrated cream and less free fat creating a less brittle material. Overall, homogenization conditions in terms of pressure and the number of passes had a strong impact on the appearance of dehydrated cream. MVD of unhomogenized cream resulted in complete separation of butter oil and non-fat milk solids during drying (not shown). Increasing the homogenization pressure resulted in less visible free fat after MVD, especially when the dry material was dispersed in hot water. Two-step homogenization was therefore beneficial for the structure of the dry material.

To further investigate the dry cream microstructure and microstructural differences between dehydrated cream produced from cream homogenized at 7 MPa and 7/3.5 MPa, the amount of extractable fat was determined. Extractable fat is undesirable in fat containing milk powders, since it can compromise the keeping quality of milk powders due to the development of oxidized flavor. Extractable fat can be categorized as (i) surface free fat, (ii) capillary fat in fat globules located at the inner capillary surface, (iii) dissolution fat located as fat globules at the surface of cracks, and (iv) outer layer fat located as fat globules at the particle surface.

Considering observations in FIG. 12, left and FIG. 13 with respect to the microstructure of MVD cream pieces, it can stated that MVD cream likely contains these four categories of extractable fat. However, the particle size, i.e., the size of the pieces of MVD cream will be much larger than in spray dried powders. It is worth noting that during extraction, particle size of dehydrated cream pieces decreased due to shear forces during solvent extraction. Table 1 shows the relative amounts of extractable fat, total fat based on total solids, and extractable fat based on total fat. The data shows that homogenization of cream before MVD had no impact on extractable fat. The extractable fat based on total fat was around 53% for both samples. The extractable fat content of whole milk powder (27.6±0.3% total fat, 4.3% moisture) extracted under the same conditions was 48% which means that milk fat in whole milk powder is less accessible to solvent than MVD cream. This higher stability of the fat globules was possibly due to more stable lipid droplets, due to a more dense protein layer at the oil-water interface created by more intense homogenization and a higher-protein-to-fat ratio in whole milk. The much smaller particle size of spray dried whole milk powder appeared to have less of an effect on the accessibility of fat to solvent extraction.

TABLE 1

| | | |
|---|---|---|
| Extractable fat | Total fat | Extractable fat of |
| [% w/w] | [% w/w] | total fat [% w/w] |

7 MPa

| | | | |
|---|---|---|---|
| 1 | 41.3 | 80.1 | 51.6 |
| 2 | 42.3 | 78.2 | 54.0 |
| 3 | 41.5 | 75.6 | 54.9 |
| AV | 41.7 | 78.0 | 53.5 |
| s | 1.9 | 2.1 | 1.7 |

7/3.5 MPa

| | | | |
|---|---|---|---|
| 1 | 41.7 | 80.1 | 52.0 |
| 2 | 46.1 | 79.8 | 57.7 |
| 3 | 38.4 | 76.7 | 50.1 |
| AV | 41.7 | 78.9 | 53.3 |
| s | 4.0 | 3.1 | 4.0 |

Color and microstructure of reconstituted dehydrated cream. The effect of homogenization on appearance, fat globule size, and microstructure of MVD dehydrated cream reconstituted by a rotor-stator homogenizer at 61-64° C. was investigated to understand the impact of cream homogenization and MVD conditions on reconstituted cream appearance, microstructure, and whipping functionality in comparison to pasteurized cream. Color measurements (FIG. 16, right) revealed that homogenization of cream before MVD had a significant (p<0.05) effect on reconstituted cream color in comparison with pasteurized cream. L* values were not different among samples. However, reconstituted cream produced from 7 MPa homogenized cream was more yellowish (a*) and greenish (b*) than pasteurized cream, although not significant in all cases. Reconstituted cream homogenized at 7/3.5 MPa showed significantly (p<0.05) higher a* and b* values, both in comparison with pasteurized cream and reconstituted dehydrated cream produced from cream homogenized at 7 MPa. The reason for this difference in color can be found in the particle size distribution as shown in FIG. 17, right. Single stage 7/3.5 MPa homogenized reconstituted dehydrated cream had a smaller fraction of fat globules in the size range around 1 μm (FIG. 17, right, green and yellow line) which can contribute to a more whiteish appearance of the reconstituted cream since particles in this size range strongly scatter visible light. Unhomogenized pasteurized cream (FIG. 17, right, pink line) is shown for size comparison. It is not clear why reconstituted MVD cream produced from two-pass homogenized cream (7/3.5 MPa) contains less of the small particle fraction than the single-pass homogenized cream (7 MPa). It is possible that the smaller particle fraction consists of MFGM fragments, which were reported before to be in this size range. These fragments might adsorb better at the oil-water interface during reconstitution of dehydrated cream produced from cream homogenized at 7/3.5 MPa than in reconstituted cream homogenized at 7 MPa, possibly due to the smaller size of MFGM fragments in cream that was homogenized twice. Cream homogenized at 7 MPa (FIG. 17, right, blue line) contains mostly larger clusters of disrupted fat globules that might lead to larger MFGM fragments with a lower emulsifying activity. Small, dispersed fat globules constitute the major fraction in 7/3.5 MPa homogenized cream (FIG. 17, right, brown line) that might be covered by smaller MFGM fragments besides milk proteins.

To better understand the reasons for differences in different samples of reconstituted cream appearance and functionality, the microstructure of the fat globules and the nature of the oil-water interface that covers them was investigated by CLSM. CLSM images of pasteurized cream, homogenized cream at 3.5, 3.5/7 MPa, and reconstituted dehydrated cream produced from cream homogenized at 7 MPa and 3.5/7 MPa stained with Nile Red (lipids) and Fast Green FCF (protein), are shown in FIG. 18, right. Pasteurized cream (FIG. 18a, right) contains larger fat globules with little stained protein at the oil-water interface. Increasing homogenization pressure from 3.5 MPa (FIG. 18b, right) to 7 MPa (FIG. 18b, right) resulted in smaller fat globules covered with protein while cluster formation also increased, as expected. Two-step homogenization at 3.5/7 MPa resulted in the disruption of fat clusters and small individual fat globules covered to a large extent with protein (FIG. 18d, right), which is similar to what would be expected from two-stage homogenization. FIG. 18e, right and FIG. 18f, right show images of the corresponding reconstituted dehydrated cream produced from cream homogenized under the latter conditions. Most interestingly, the reconstituted fat globules are only covered to a small extent by protein, similar to fat globules in pasteurized cream, but fat globules are larger than in the pasteurized cream. Particle sizes of homogenized fat globules before MVD had no effect on particle size after reconstitution. As observed in the particle size distribution results (FIG. 18, right), reconstituted dehydrated cream produced from 7 MPa homogenized cream contained more small particles in between the large red fat globules that could be MFGM fragments.

Besides protein, the oil-water interface of native milk fat globules is covered by phospholipids. In its native state, the milk fat globule membrane is a triple-layer of phospholipids and protein originating from the apical side of the secretory cell membrane in the mammary gland. Since a dense layer of protein covering fat globules was not visible on the surface of fat globules in reconstituted dehydrated cream, coverage with phospholipids from the MFGM material was likely. This similar surface coverage might result in a functionality of reconstituted cream similar to pasteurized cream.

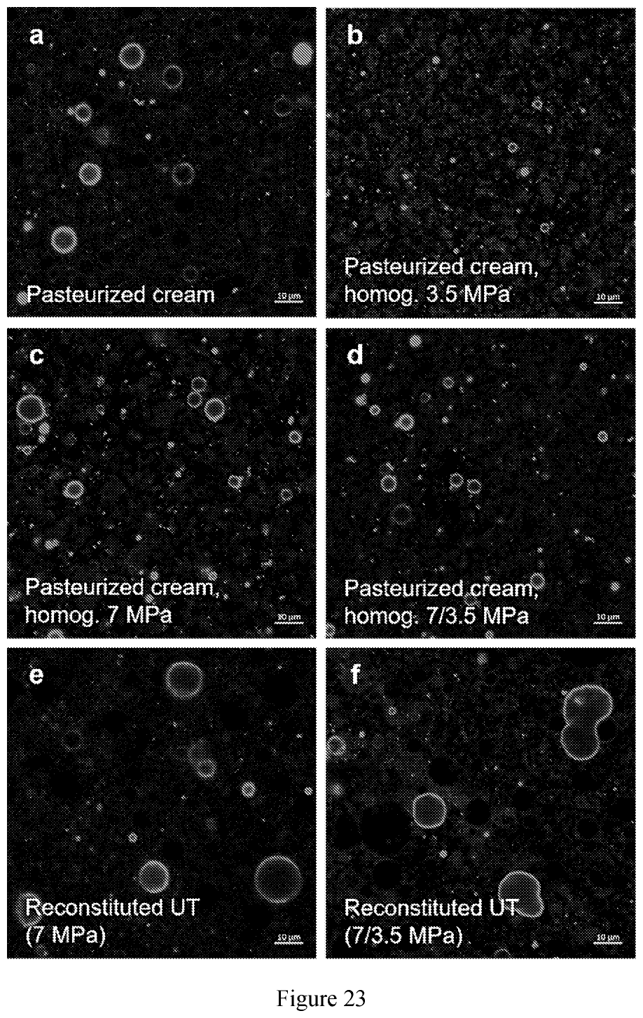

FIG. 23 shows CLSM images (cross section) of cream samples stained with Rd-DOPE to depict the spatial distribution of phospholipids in pasteurized cream (FIG. 23a), homogenized cream (FIG. 23b-d), and reconstituted MVD cream (FIG. 23e-f). These images show that mostly the larger fat globules are covered with phospholipids, and that larger fat globules in reconstituted dehydrated cream appear covered with phospholipids, like fat globules in pasteurized cream.

It was previously found that oil-in-water emulsions prepared with MFGM material isolated from raw or pasteurized cream were more heat stable than emulsions stabilized by caseins and/or whey proteins. Moreover, MFGM material adsorbed at the oil-water interface could not be displaced by synthetic surfactants, indicating a low surface tension of MFGM stabilized emulsions. The emulsification activity, microstructure, and functionality (whippability and foam stability) of lipid droplets coated with MFGM have been studied to some extent. However, the impact of mechanical actions, i.e., mechanical damage during pumping, churning, and whipping, on the properties of MFGM stabilized quasi-native emulsions has only been studied to a very limited extent to date. The present disclosure contributes to a better understanding of these effects.

To summarize, fat globules in MVD dehydrated cream reconstituted using a rotor-stator homogenizer are larger in size but appear similar with respect to coverage with protein and phospholipids, under the reconstitution conditions used herein. Homogenization before MVD was a necessary step to prevent separation of butter oil and non-fat milk solids during MVD but different homogenization conditions did not affect the size and surface coverage of fat globules in reconstituted cream. Changes induced by homogenization increased the emulsion stability, but also changed the functionality of reconstituted cream. Combining homogenization, MVD, and suitable reconstitution conditions allows to recreate fat globules with about twice the average size and similar surface coverage compared to fat globules in pasteurized cream. These similarities in structure are likely to lead to similarities in functionality, e.g., whipping properties, which will be discussed below.

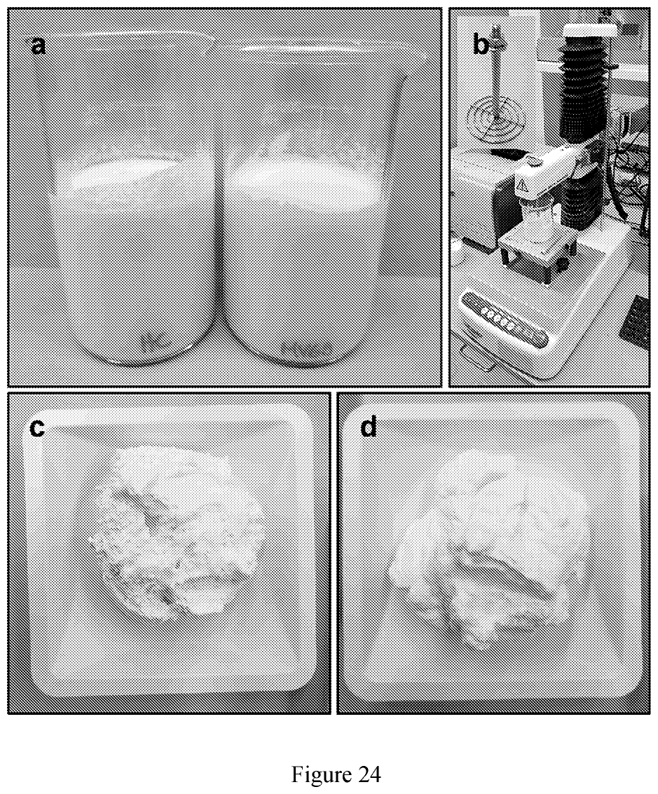

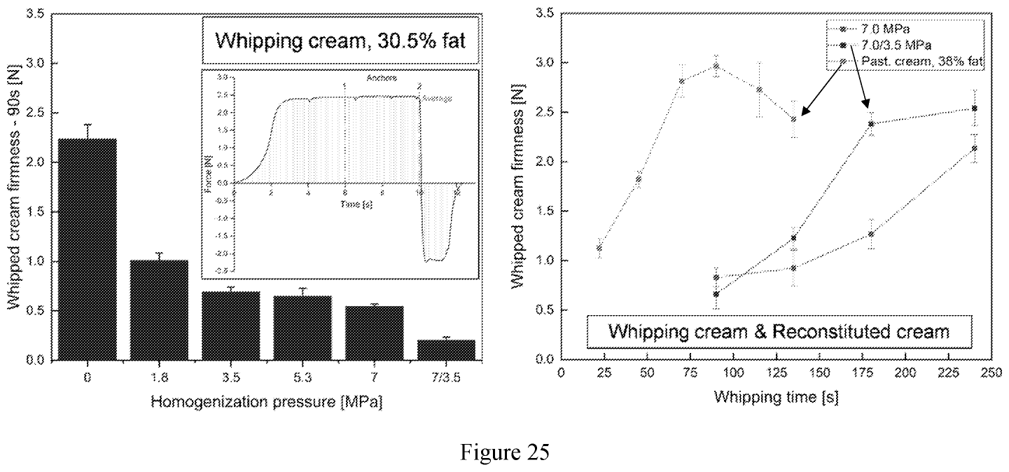

Whipping properties of reconstituted dehydrated cream. FIG. 24a shows a visual comparison between pasteurized heavy cream (HC, left) and reconstituted dehydrated cream (MV69, right) in a beaker. These two samples are very similar in appearance. The visual appearance of whipped cream obtained from pasteurized cream and whipped cream from MVD reconstituted cream, at peak firmness, was also very similar (FIG. 24c). The whipped cream firmness over time was determined using a Texture Analyzer equipped with a cream probe (FIG. 24b). FIG. 25 (left) shows whipped cream firmness at 30.5% fat after 90 s whipping as a function of homogenization pressure, and the insert shows a texture analyzer graph that depicts the force plot. Whipped cream firmness data correspond to the whipping properties of cream before evaporation and MVD. Whipped cream firmness data in FIG. 25a serves as a control for the whipped cream produced from reconstituted dehydrated cream. Whipped cream firmness at 90 s whipping time decreased strongly with increasing homogenization intensity, with 0 MPa homogenized cream (passed through the homogenizer without applying pressure) showing the highest firmness, and the two-step homogenized cream the lowest firmness. A direct comparison with the whipping behavior of spray dried cream powders is important. Before spray drying, cream is typically subjected to more intense homogenization conditions than those used herein. Preliminary experiments conducted with reconstituted spray dried cream powder showed very poor whipping properties of this product (data not shown). Essentially, no whipped cream or butter formation could be obtained from such spray dried cream products. This means that major functionalities of cream are lost when cream is homogenized and spray dried. After reconstitution, fat globules in reconstituted spray dried cream powders remain very small and covered by a dense layer of protein after reconstitution. By contrast, fat globules in MVD cream appear similar in structure as those in pasteurized cream, resulting in similar whipping properties.

FIG. 25 (right) shows the whipped cream firmness of pasteurized cream (green squares) as a function of whipping time as compared to whipped reconstituted dehydrated cream produced from cream homogenized at 7 MPa (blue squares) and 3.5/7 MPa (purple squares). The fat content of all cream samples was 38%. Using the same percent fat was very important, as the fat content affects firming rate and peak whipped cream firmness (data not shown). FIG. 25 (right) shows that whipped cream firming rate was fastest for pasteurized whipping cream. Whipped cream firming rate for reconstituted dehydrated cream produced from 7/3.5 MPa homogenized cream was slower than pasteurized cream, but faster than reconstituted cream prepared from 7 MPa homogenized cream. This faster firming rate of the two-stage homogenized cream could be related to differences observed in the number of MFGM particles, the minor fraction in the size distribution (FIG. 17, right) and the higher intensity of proteinaceous material (in green) in the serum phase of 7 MPa homogenized cream (see FIGS. 18e and f, right). More MFGM material in the serum phase could indicate the presence of more protein (caseins and whey proteins) at the oil-water interface that stabilizes fat globules better against cluster formation during whipping than MFGM material. Also, the whipping rate was slower and the peak firmness for reconstituted dehydrated cream produced from 3.5/7 MPa homogenized cream was almost as high as that of pasteurized whipping cream. Therefore, MVD combined with appropriate homogenization before drying and reconstitution conditions represents a novel approach to preserve cream solids and retain full functionality of cream with respect to whipping properties.

Current technologies for preservation of milk fat such as butter making, production of butter oil/anhydrous milk fat (AMF), or spray drying to produce cream powder, either produce low value byproducts, convert milk fat into products that do not provide the same level of functionality as the original cream, or require refrigerated or frozen storage and transport. Dehydrated cream produced by MVD offers an opportunity to overcome these challenges. This study demonstrated that a combination of appropriate pre-drying conditions (i.e., homogenization) and optimal MVD parameters resulted in desirable dehydrated cream structure, reconstituted cream microstructure, and whipping properties. In addition, insights into why the MVD cream retained good whipping functionality were obtained. Further optimization of this process could be achieved by conducting a more detailed analysis of the effect of homogenization and reconstitution conditions with respect to shear rate, temperature, and time. Besides whipping, other applications for reconstituted MVD cream, including use in cheese, butter, or ice cream could be explored, and may lead to unique opportunities in regions without a steady raw milk supply or lack of a reliable cold chain. MVD cream could be a highly functional shelf stable product that is characterized by a high resource efficiency since less energy is consumed during the centrifugal separation of cream as compared to the evaporation of skim milk for water removal.

### Example 7

This example provides a description of one embodiment of the present disclosure.

Various experiments were conducted to assess the shelf-life of the microwave vacuum dehydrated (MVD) cream of the present disclosure. Cream was processed at optimal conditions, packaged similar to how it would be packaged in industry: flushed with N₂, packaged in airtight metalized barrier pouches. Storage conditions for the MVD cream powder: 25° C. (room temperature) and 40° C. (summer/hot climate temperature). Monthly analyses for water activity, color, whipped cream firmness, particle size, and lipid oxidation (volatile compounds) were then performed.

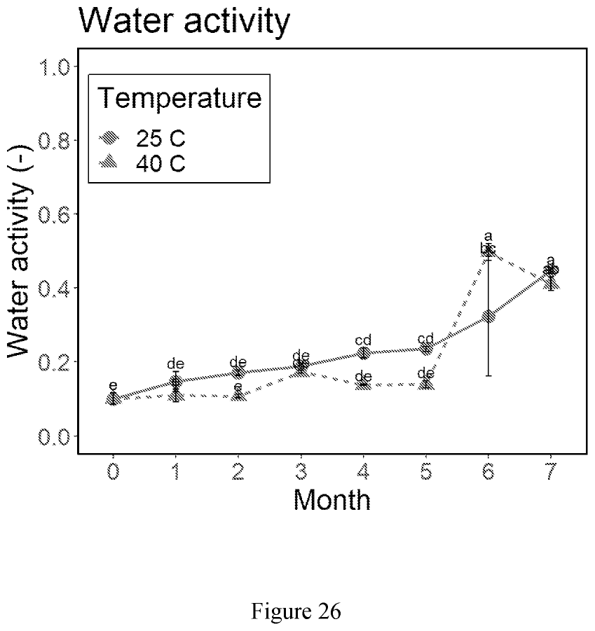

FIG. 26 shows the water activity for the sample over the course of several months. There was an increase after 4 months. After 6 months, a_{w} was greater than 0.4.

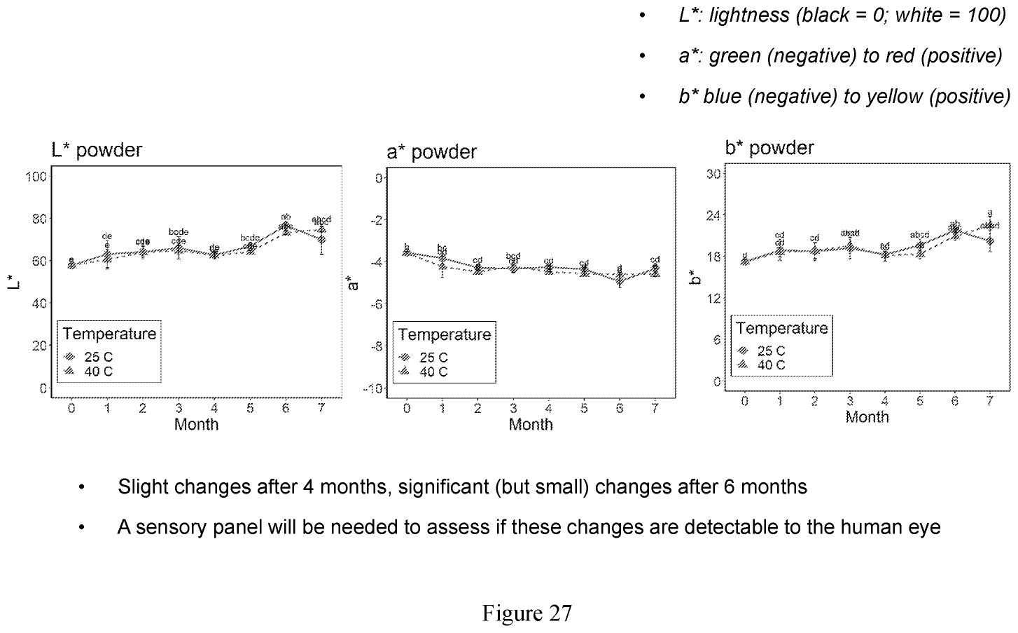

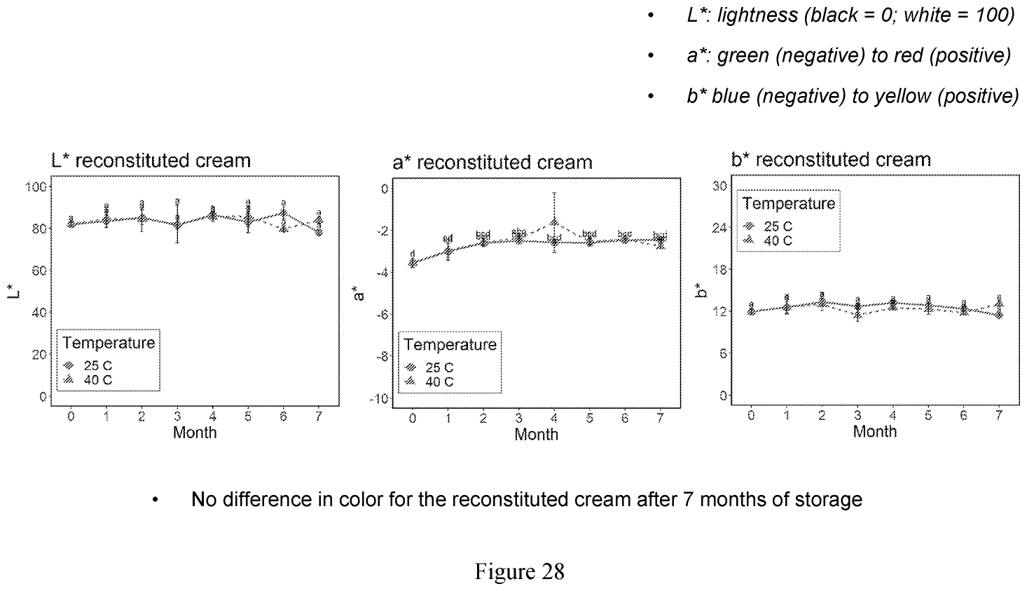

The color of the powder and the reconstituted cream was measured over several months (FIGS. 27 and 28).

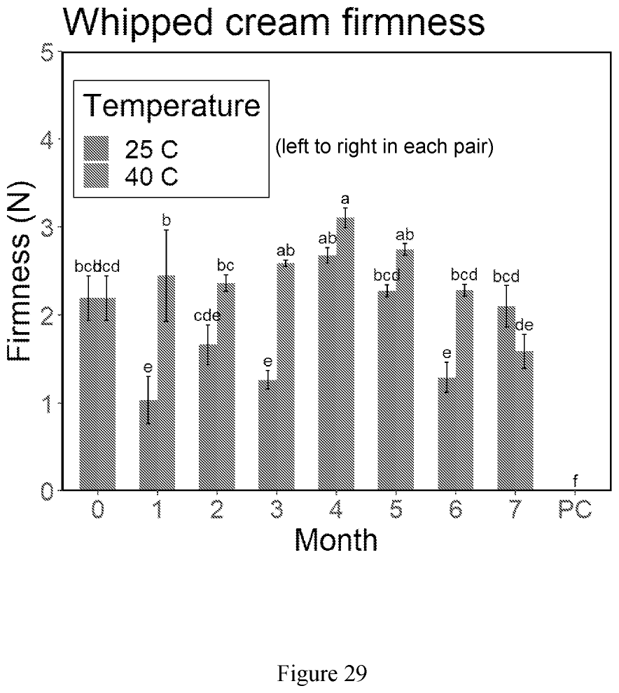

The firmness of the whipped reconstituted cream was also measured (FIG. 29). Some variability was observed, but it may have been from sample-to-sample variation. No trend was observed for samples stored at 25° C., but a decrease in firmness of the whipped cream was obtained from reconstituted powders was noticed for samples stored at 40° C. above 6 months.

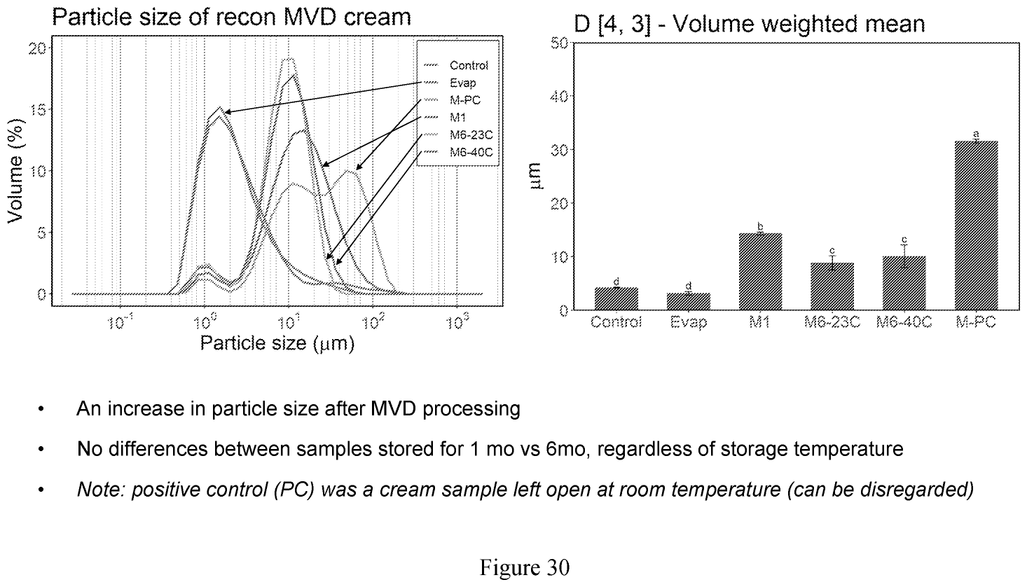

The particle size of the reconstituted cream was also assessed. These data are visible in FIG. 30.

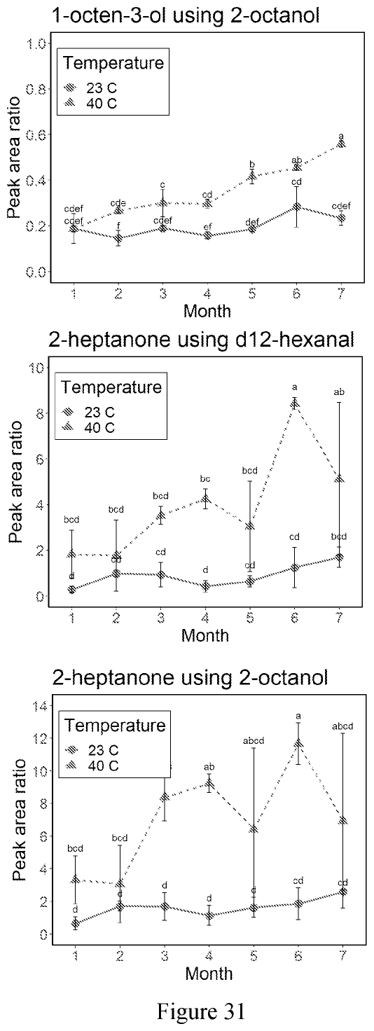

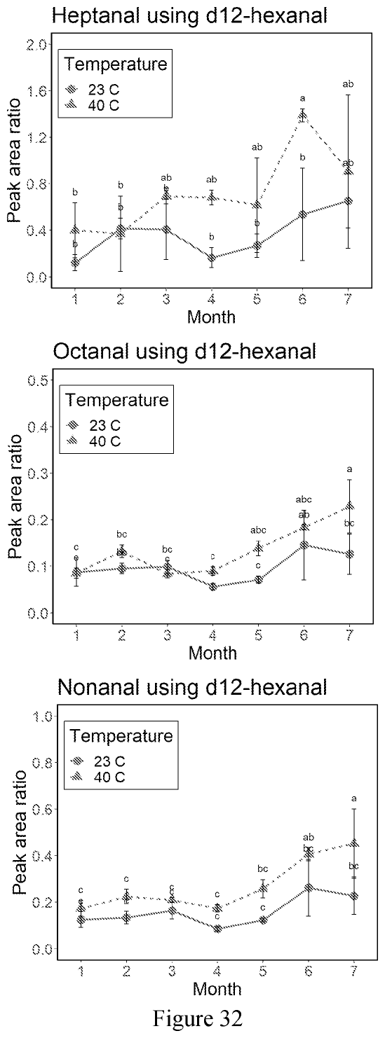

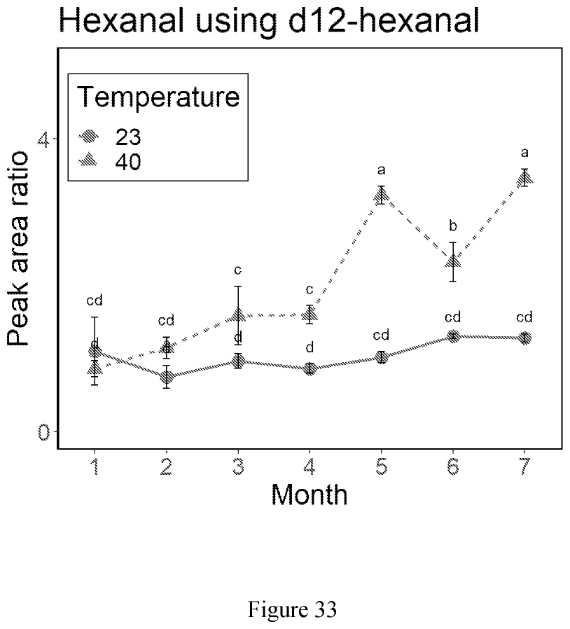

Lipid oxidation of the MVD cream powder over time was also assessed. Traditional method to assess oxidation (peroxide value) is useful, but does not provide specific information on volatile compounds that may have a negative impact on consumers. Gas chromatography was used to quantify the following compounds that result from milk fat oxidation: 1-octen-3-ol, 2-heptanone, Heptanal, Hexanal, Nonanal, Octanal. All compounds showed increases after 6 months of storage, particularly for the powders stored at 40 C; these increases were most pronounced for 1-octen-3-ol, 2-heptanone, Heptanal. These data are seen in FIGS. 31-33.

Although the present disclosure has been described with respect to one or more particular embodiments and/or examples, it will be understood that other embodiments and/or examples of the present disclosure may be made without departing from the scope of the present disclosure.

1. A dehydrated cream product, comprising:
45-86% fat by mass; and,
less than or equal to 1.5% water by mass,
wherein at least a portion of the fat is fat globules, and when the dehydrated cream product is reconstituted, at least 80% of the fat globules have a longest linear dimension of 1 to 20 μm.

2. The dehydrated cream product of claim 1, wherein the dehydrated cream product does not comprise preservatives, hydrocolloids, stabilizers, and/or emulsifiers.

3. The dehydrated cream product of claim 1, wherein the fat comprises or is milk fat.

4. The dehydrated cream product of claim 1, wherein the fat comprises less than 50% by mass vegetable fats.

5. The dehydrated cream product of claim 1, wherein the protein-to-fat ratio is greater than or equal to 1:10.

6. The dehydrated cream product of claim 1, wherein the protein-to-fat ratio is greater than or equal to 1:20.

7. A method for producing a dehydrated cream product, comprising:
providing a dairy cream composition comprising emulsified solids comprising fat, wherein at least a portion of the fat is present as fat globules, wherein the dairy cream composition has a fat content of 8-36% by mass;
homogenizing the dairy cream composition such that 80% of the fat globules or clusters of fat globules of the dairy cream composition have a diameter of 0.25-10 μm; and
subjecting the homogenized dairy cream composition to vacuum drying to result in a dehydrated cream product having a fat content of 45-86% by mass, and a moisture content of less than or equal to 1.5% by mass.

8. The method of claim 7, wherein the homogenizing comprises:
subjecting the cream composition to high-pressure homogenization of 0.01-7 MPa; and
subjecting the cream composition to high-pressure homogenization of 0.01-3.5 MPa.

9. The method of claim 7, wherein the vacuum drying is microwave vacuum drying.

10. The method of claim 7, wherein the dairy cream product has a temperature lower than or equal to 65° C., and the method further comprises subjecting the cream composition to microwave radiation of 0.1-2.6 W per g of dairy cream composition for 5-90 minutes, wherein the dairy cream composition comprises a layer having a thickness of 1-4 mm.

11. The method of claim 7, further comprising:
evaporating the homogenized cream composition prior to vacuum drying resulting in formation of solids at a concentration 30-50% by mass.

12. The method of claim 11, wherein the concentration of the solids is 36-50% by mass.

13. A dehydrated cream product prepared by the method of claim 7.

14. The dehydrated cream product of claim 13, wherein at least a portion of some of the fat is fat globules, and when the dehydrated cream product is reconstituted, at least 80% of the fat globules have a longest linear dimension of 1 to 15 μm.

15. A method of making reconstituted cream, butter, or whipped cream, comprising:
adding an aqueous media to the dehydrated cream product of claim 1;
mixing the aqueous media and dehydrated cream product to form a reconstituted heavy cream, wherein the mixing is high shear mixing.

16. The method of claim 15, further comprising whipping the reconstituted heavy cream and/or churning the reconstituted heavy cream.

17. The method of claim 15, wherein the high shear mixing has local shear rates of at least 10⁻⁴ s⁻¹ and a power density of at least 10⁹ J m⁻³.

18. A food product, comprising the reconstituted cream made by the method of claim 15.

19. The food product of claim 18, wherein the food product is a beverage.

20. The food product of claim 18, wherein the food product is a beverage, yogurt, cheese, cream, sauce, spread, dip, condiment, or dressing.

21. The food product of claim 18, wherein the food product is a dessert, a snack, a baked good, a pastry, or a bread product.

22. A method for preparing a dehydrated milk cream product, the method comprising:
obtaining milk cream comprising 20-35% w/w fat content and has a protein-to-fat ratio of 1:10 to 1:21;
homogenizing the milk cream 7 MPa in the first stage and 3.5 MPa in the second stage at 65-70° C. to generate a homogenized milk cream;
evaporating the homogenized milk to 43% w/w solids to generate an evaporated milk cream; and
microwave vacuum drying the evaporated milk cream to generate a dehydrated milk cream product with 45-86% w/w fat, and a residual moisture content of 1.5% w/w or less corresponding to a water activity of 0.35 or less.

23. The method of claim 22, wherein the milk cream comprises 26-30% fat and has a protein-to fat ratio of 1:11 to 1:20.

24. The method of claim 23, wherein the protein-to-ratio is 1:11 to 1:15.

25. The method of claim 22, wherein homogenizing comprises homogenization at 0-10 MPa single stage or two-stage, single pass, or multiple passes at 45-85° C.

26. The method of claim 22, wherein evaporating comprises concentrating cream to 36-50% w/w solids at 45-85° C. in a single or multi effect evaporator.

27. The method of claim 22, wherein drying comprises microwave drying process that is batch or continuous, at a drying pressure of 1-10 kPa and a specific power input of 0.2-3 W g⁻¹ product at the beginning of the drying process.

28. The method of claim 22, wherein drying comprises radio frequency drying, spray drying, freeze drying, drum drying, or vacuum drum drying process.

29. The method of claim 22, wherein the milk cream is pasteurized, high heat treated, ultra-pasteurized, ultra-high temperature heat treated, or sterilized.

30. The method of claim 22, further comprising adding an additive to the dehydrated milk cream before drying or after microwave vacuum drying as a dry blend.

31. The method of claim 30, wherein the additive is a colorant, a sweetener, a salt, a flavoring, an emulsifier, and/or a mixture of fruits, vegetables, and spices or other food preparations.

32. A method for reconstituting a dehydrated milk cream product, the method comprising:
obtaining a dehydrated milk cream product by the method of claim 22;
adding water to the dehydrated milk cream product in a ratio of 5:3 up to 20:17 w/w (water: dry cream), preferably 4:3 w/w (water: dry cream), to generate a premix solution;
heating the premix to 50-80° C. and/or heating the water to 70-100° C. to achieve the desired temperature when mixed with the dried cream;
blending the premix solution to generate reconstituted dried cream using a device that is capable to achieve local shear rates or gradients of at least 10⁻⁴ s⁻¹ and a power density of at least 10⁹ J m⁻³ to yield particles in the emulsion no larger than 20 μm in diameter and no large aggregates or clusters are present and preferably a mean volume-based average diameter d_{4,3} of 7-8 μm.

33. The method of claim 32, wherein blending comprises blending in a kitchen blender for 1-5 minutes.

34. The method of claim 33, wherein blending comprises blending with at rotor-stator mixer at 15,000-24,000 RPM.

35. The method of claim 34, wherein blending comprises blending with a rotor-stator mixer at 15,000-24,000 RPM for 1-5 min and subsequent homogenization at 0-3.5 MPa and 55-75° C.

36. A method for reconstituting a dehydrated milk cream product, the method comprising:
adding water to the dehydrated milk cream product of claim 1 in a ratio of 5:3 up to 20:17 w/w (water: dry cream), preferably 4:3 w/w (water: dry cream), to generate a premix solution;
heating the premix to 50-80° C. and/or heating the water to 70-100° C. to achieve the desired temperature when mixed with the dried cream;
blending the premix solution to generate reconstituted dried cream using a device that is capable to achieve local shear rates or gradients of at least 10⁻⁴ s⁻¹ and a power density of at least 10⁹ J m⁻³ to yield particles in the emulsion no larger than 20 μm in diameter and no large aggregates or clusters are present and preferably a mean volume-based average diameter d_{4,3} of 7-8 μm.

37. The method of claim 36, wherein blending comprises blending in a kitchen blender for 1-5 minutes.

38. The method of claim 36, wherein blending comprises blending with at rotor-stator mixer at 15,000-24,000 RPM.

39. The method of claim 38, wherein blending comprises blending with a rotor-stator mixer at 15,000-24,000 RPM for 1-5 min and subsequent homogenization at 0-3.5 MPa and 55-75° C.
